(19) United States
(12) Patent Application Publication
(10) Pub. No.: US 2026/0266607 A1
(43) Pub. Date: Sep. 10, 2026

(54) SURVEYING DEVICE

(71) Applicant: TOPCON CORPORATION, Itabashi-ku (JP)

(72) Inventors: Taichi Yuasa, Tokyo-to (JP); Nobuyuki Nishita, Tokyo-to (JP)

(21) Appl. No.: 19/544,063

(22) Filed: Feb. 19, 2026

(30) Foreign Application Priority Data
Mar. 5, 2025 (JP) 2025-034327

(51) Int. Cl. G01C 15/00; G01C 15/06; G02B 5/09; G02B 17/04

(52) U.S. Cl. CPC G01C 15/002; G01C 15/06; G02B 5/09; G02B 17/045

(57) ABSTRACT

In a surveying device 1 having a rotation unit 18 that houses part or all of the optical system of the surveying device, the rotation unit has an instrument center of the surveying device; the surveying device has a target as a second optical system having a retroreflective function and a target center; the optical system of the surveying device has a collimation optical axis, and the target has a reference optical axis; the target is provided with the target center coinciding or substantially coinciding with the instrument center; and, upon rotation of the rotation unit, the reference optical axis of the target is configured to coincide or substantially coincide with a direction of the collimation optical axis of the optical system of the surveying device.

### TECHNICAL FIELD

The present disclosure relates to measuring the installation position of a surveying device.

### BACKGROUND ART

In surveying work, accurately measure it is sometimes necessary to accurately measure the position of a surveying device using another surveying device.

For example, in a traverse survey using two surveying devices, the positions of the surveying devices are measured while the installation positions of the surveying devices are changed to carry out the survey. At this time, if there is an error in the position measurement of the surveying devices, it will affect the measurement accuracy, so it is desirable to be able to accurately measure the position of the surveying device.

Conventionally, to measure the position of a surveying device, a corner cube is attached to a predetermined position of the surveying device, for example, to the handle used to carry the device, and the position of the surveying device is measured by measuring the corner cube.

In this case, an offset occurs between the measurement reference point of the surveying device (instrument center point)

and the optical center of the corner cube, and this offset can cause measurement errors. Furthermore, installation errors can occur when installing the corner cube on the surveying device, which also affects measurement accuracy.

### CITATION LIST

### Patent Document

PATENT DOCUMENT 1: Japanese Unexamined Patent Publication No.2024-148128

PATENT DOCUMENT 2: Japanese Unexamined Patent Publication No.2024-116462

PATENT DOCUMENT 3: Japanese Unexamined Patent Publication No.2024-48705

PATENT DOCUMENT 4: Japanese Patent No.3551266

### SUMMARY OF THE INVENTION

### Technical Problems

There is a need to accurately measure the installation position of a surveying device. The present disclosure addresses this technical problem.

### Solution to the Problems

The present disclosure relates to a surveying device comprising: a rotation unit that accommodates at least part or all of an optical system of the surveying device, the rotation unit having an instrument center of the surveying device; a target

that serves as a second optical system having a retroreflective function and a target center; wherein the optical system of the surveying device has a collimation optical axis, and the target has a reference optical axis; wherein the target is provided so that the target center coincides or substantially coincides with the instrument center; and wherein, by rotation of the rotation unit, the reference optical axis of the target is configured to coincide or substantially coincide with a direction of the collimation optical axis of the optical system of the surveying device.

### Advantage of the Invention

According to the present disclosure, the installation position of the surveying device can be measured with high accuracy.

### BRIEF DESCRIPTION OF THE DRAWINGS

FIG. 1 is a front view of a surveying device according to a first embodiment of the present disclosure.

FIG. 2 is a schematic diagram of the main body of the surveying device.

FIG. 3 is a schematic diagram showing the optical system of the surveying device.

FIG. 4 is an explanatory diagram of position measurement between surveying devices.

FIG. 5A is a schematic diagram of the vertical rotation unit of the second embodiment.

FIG. 5B is a schematic diagram of the vertical rotation unit of a modified version of the second embodiment.

FIG. 6 is a schematic diagram of the vertical rotation unit of the third embodiment.

FIG. 7 is a schematic diagram of the vertical rotation unit of the fourth embodiment.

FIG. 8A is a schematic diagram of the vertical rotation unit of the fifth embodiment.

FIG. 8B is a schematic diagram of the vertical rotation unit of a modified version of the fifth embodiment.

FIG. 9 is a schematic diagram of the vertical rotation unit of the sixth embodiment.

FIG. 10 is a schematic diagram of the vertical rotation unit of the seventh embodiment.

FIG. 11A is an explanatory diagram of the window portion that houses the vertical rotation unit of the seventh embodiment, and is an elevation view as viewed in the direction of arrow A in FIG. 10.

FIG. 11B is an explanatory diagram of the window portion that houses the vertical rotation unit of the seventh embodiment, and is an elevation view as viewed in the direction of arrow A in FIG. 10.

FIG. 12 is a side view of the optical member of the vertical rotation unit of the eighth embodiment.

FIG. 13 is a perspective view of the optical member of the vertical rotation unit from below.

FIG. 14 is a rear view of the optical member of the vertical rotation unit.

FIG. 15 is a front view of the optical member of the vertical rotation unit.

FIG. 16 is a side view of the optical member of the vertical rotation unit of the ninth embodiment.

FIG. 17 is a rear view of the optical member of the vertical rotation unit.

FIG. 18 is a three-dimensional view of the optical member of the vertical rotation unit from the side.

FIG. 19: is a three-dimensional view of the optical member of the vertical rotation unit from below.

FIG. 20: is a three-dimensional view of the optical member of the vertical rotation unit from above.

FIG. 21: An external view of a total station according to the tenth embodiment.

FIG. 22: A schematic diagram showing the measuring state of the optical system in the tenth embodiment.

FIG. 23: A schematic diagram showing the measured state of the optical system in the tenth embodiment.

FIG. 24: A schematic diagram showing the measuring state of the optical system in the eleventh embodiment.

FIG. 25: A schematic diagram showing the measured state of the optical system in the eleventh embodiment.

FIG. 26: A schematic front view of the optical system in the eleventh embodiment.

FIG. 27: A schematic diagram of the optical system in the twelfth embodiment.

FIG. 28: A schematic diagram of the optical system in the thirteenth embodiment.

FIG. 29 is a schematic diagram of the optical system of a modified example of the thirteenth embodiment.

FIG. 30 is a schematic plan view of a surveying device according to the fourteenth embodiment.

FIG. 31 is a side view of the vertical rotation unit of the surveying device.

FIG. 32 is a schematic diagram showing the optical system of the vertical rotation unit of the fifteenth embodiment.

FIG. 33 is a schematic diagram showing the optical system of the vertical rotation unit of a modified example of the fifteenth embodiment.

FIG. 34 is a schematic diagram of the optical system of the sixteenth embodiment.

FIG. 35 is a schematic diagram of the optical system of the vertical rotation unit of the sixteenth embodiment.

FIG. 36 is a schematic plan view of the optical system of the seventeenth embodiment.

FIG. 37A is a schematic diagram of the rotation unit of the eighteenth embodiment,

FIG. 37B is a schematic diagram of the rotation unit of a modified example of the eighteenth embodiment.

FIG. 38 is an explanatory diagram of a traverse survey using a surveying device according to the present disclosure.

### DESCRIPTION OF EMBODIMENT

Hereinafter, embodiments of the present disclosure will be described with reference to the drawings.

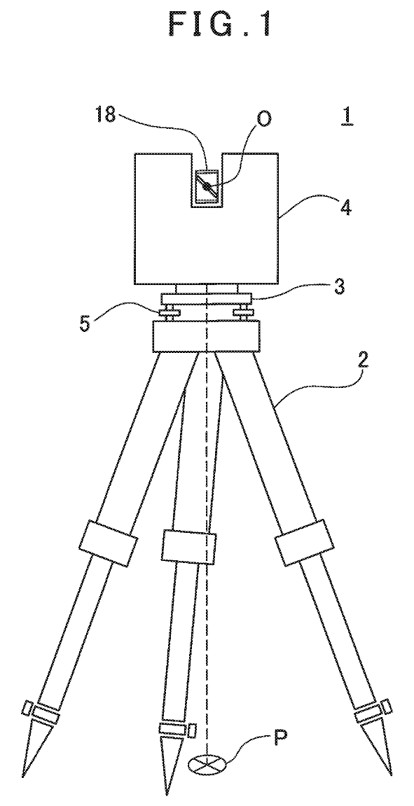

First, with reference to FIGS. 1 to 3, a description is given of a first embodiment of a surveying device according to the present disclosure.

Note that the present disclosure is applicable to various surveying devices such as laser scanners and total stations, which have a measurement reference point (the instrument center). In the following, by way of example, a case is described in which the surveying device is a laser scanner.

The surveying device 1 is composed of a leveling unit 3, which is attached to a tripod 2, and a surveying-device main body 4, which is mounted on the leveling unit 3.

The surveying-device main body 4 is placed at a setup point P via the tripod 2. The leveling unit 3 includes leveling screws 5, and the main body 4 is leveled by operating the leveling screws 5.

The surveying-device main body 4 has an instrument center C. When the surveying-device main body 4 is leveled, the surveying device 1 is set up such that the instrument center C is located on a vertical line passing through the setup point P.

The surveying-device main body 4 includes a fixed unit 6, a support unit 7, a horizontal rotation shaft 8, a horizontal bearing 9, a horizontal rotation motor 11 serving as a horizontal rotation drive, a horizontal angle encoder 12 serving as a horizontal angle detection unit, a vertical rotation shaft 13, a vertical bearing 14, a vertical rotation motor 15 serving as a vertical rotation drive, a vertical angle encoder 16 serving as a vertical angle detection unit, a rotation unit 18 including a scanning mirror 17, an operation panel 19 that also functions as an operation unit and a display unit, a calculation/control unit 21, a storage unit 22, a distance measurement portion 23, and so forth (these are all provided or housed within the main body 4). Note that as the calculation/control unit 21, a CPU specialized for this device or a general-purpose CPU may be used.

The horizontal bearing 9 is fixed to the fixed unit 6. The horizontal rotation shaft 8 has a vertical axis 8a and is rotatably supported by the fixed unit 6 via the horizontal bearing 9. The support unit 7 is supported on the horizontal rotation shaft 8 so as to rotate horizontally together with the horizontal rotation shaft 8.

Between the horizontal bearing 9 and the support unit 7, the horizontal rotation motor 11 is provided, and this horizontal rotation motor 11 is controlled by the calculation/control unit 21. Through control of the horizontal rotation motor 11 by the calculation/control unit 21, the support unit 7 is rotated about the axis 8a.

The horizontal angle encoder 12 detects the relative rotational angle of the support unit 7 with respect to the fixed unit 6. A detection signal from the horizontal angle encoder 12 is input to the calculation/control unit 21, which calculates horizontal angle data based on the detection signal and performs feedback control of the horizontal rotation motor 11 based on the horizontal angle data.

The support unit 7 is further provided with the vertical rotation shaft 13, which has a horizontal axis 13a. The vertical rotation shaft 13 is rotatably supported by the support unit 7 via the vertical bearing 14. The intersection of the axis 8a and the axis 13a is the emission position of distance-measurement light and the origin of the coordinate system of the surveying-device main body 4 (the measurement reference point: instrument center).

The support unit 7 is formed with a recess 24. One end of the vertical rotation shaft 13 extends into the recess 24, and the scanning mirror 17 is fixed to that one end. The rotation unit 18, which includes the scanning mirror 17, is housed in the recess 24. The vertical angle encoder 16 is provided on the other end of the vertical rotation shaft 13.

The vertical rotation motor 15 is provided on the vertical rotation shaft 13. The calculation/control unit 21 controls the vertical rotation motor 15. By driving the vertical rotation motor 15, the calculation/control unit 21 rotates the vertical rotation shaft 13, thereby rotating the scanning mirror 17 about the axis 13a.

The vertical angle encoder 16 detects the rotational angle of the scanning mirror 17. A detection signal from the vertical angle encoder 16 is input to the calculation/control unit 21, which calculates vertical angle data for the scanning mirror 17 based on the detection signal and performs feedback control of the vertical rotation motor 15 based on the vertical angle data.

The horizontal angle data, vertical angle data, and measurement results calculated by the calculation/control unit 21 are stored in the storage unit 22. As the storage unit 22, a variety of storage means may be used, such as an HDD as a magnetic storage device, a CD or DVD as an optical storage device, or a memory card or USB memory as a semiconductor storage device. The storage unit 22 may be detachable relative to the support unit 7, or data may be sent to an external storage device or external data processing device via unillustrated communication means.

Various programs are stored in the storage unit 22, including a sequence program to control the distance-measurement operation, a calculation program to calculate distance by the distance-measurement operation, a calculation program to calculate angles based on the horizontal angle data and vertical angle data, and a program to calculate three-dimensional coordinates of a desired measurement point based on distance and angle. Various processes are executed by running these programs through the calculation/control unit 21.

The operation panel 19 is, for example, a touch panel and serves dually as an operation unit that performs various operations such as instructing distance measurement or changing measurement conditions (e.g., changing the measurement point interval), and as a display unit that displays distance-measurement results, images, and the like.

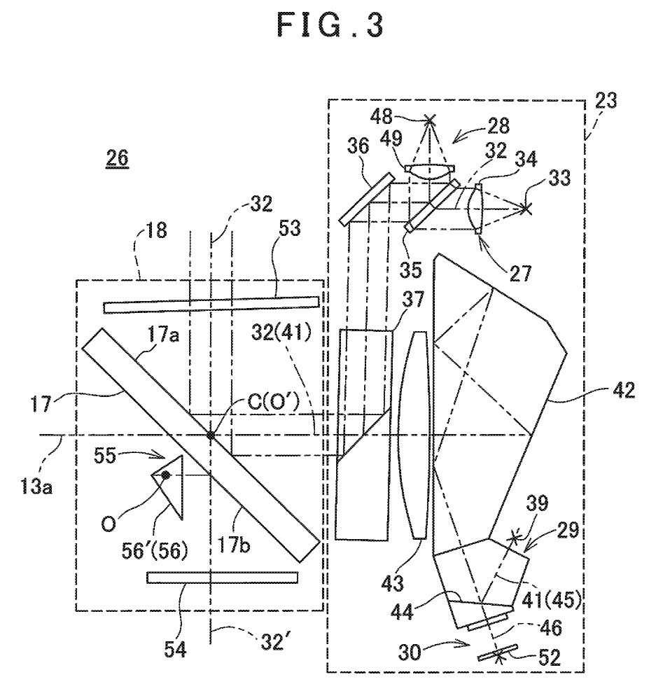

FIG. 3 shows an optical system 26 of the surveying device 1. The optical system 26 includes the distance measurement portion 23, which is housed in the support unit 7, the scanning mirror 17, which is housed in the rotation unit 18, and so forth.

Referring to FIG. 3, the distance measurement portion 23 will be described. In the following description, a condition in which an emission axis 32 (described later) of distance-measurement light is vertical is taken as a reference. The distance measurement portion 23 is not limited to the specific form shown in FIG. 3; other known distance measurement portions disclosed in Patent Document 1, Patent Document 2, Patent Document 3, or the like may also be applied.

The distance measurement portion 23 includes a distance-measurement-light emission portion 27, a tracking-light emission portion 28, a distance-measurement-light receiving portion 29, and a tracking-light receiving portion 30. The distance-measurement-light emission portion 27 and the tracking-light emission portion 28 share a common emission optical system, and the distance-measurement-light receiving portion 29 and the tracking-light receiving portion 30 share a common receiving optical system. A distance-measurement section is constituted by the distance-measurement-light emission portion 27 and the distance-measurement-light receiving portion 29, and a tracking section is constituted by the tracking-light emission portion 28 and the tracking-light receiving portion 30.

As described later, the distance measurement portion 23 is configured such that distance-measurement light emitted from the distance-measurement-light emission portion 27 is emitted onto a measurement object, and the reflection of this distance-measurement light from the measurement object is received by the distance-measurement-light receiving portion 29 to perform distance measurement. Further, the distance measurement portion 23 is configured such that the tracking light, which has a different wavelength from the distance-measurement light, is emitted onto the measurement object from the tracking-light emission portion 28; the reflection of this tracking light from the measurement object is received by the tracking-light receiving portion 30; and tracking of the measurement object is performed based on the result of reception.

The emission optical system has a emission optical axis 32. The distance-measurement-light emission portion 27 includes a light-emitting element 33, for instance a laser diode (LD), that emits distance-measurement light along the emission optical axis 32, and further includes, in order from the emission side, a emission lens 34, a dichroic mirror 35, a mirror 36 disposed on the transmitted-light axis of the dichroic mirror 35, a reflecting prism 37 disposed on the reflection optical axis of the mirror 36, and the scanning mirror 17 disposed on the reflection optical axis of the reflecting prism 37. When the scanning mirror 17 is fixed and distance-measurement light reflected by this scanning mirror 17 is directed onto a measurement object, the emission optical axis 32 is equivalent to a collimation optical axis.

The scanning mirror 17 has reflective surfaces on both sides: the face opposite the reflecting prism 37 is defined as a first reflective surface 17a, and the rear surface of the scanning mirror 17 is defined as a second reflective surface 17b. The reflection optical axis of the first reflective surface 17a is deflected at a right angle relative to the reflection optical axis of the reflecting prism 37.

The reflection optical axis of the reflecting prism 37 coincides with the axis 13a, and the scanning mirror 17 rotates around the reflection optical axis of the reflecting prism 37 (i.e., the axis 13a). The reflection optical axis of the first reflective surface 17a rotates in a plane orthogonal to the reflection optical axis of the reflecting prism 37.

The dichroic mirror 35, mirror 36, reflecting prism 37, and scanning mirror 17 (i.e., the first reflective surface 17a) and the like constitute the emission optical system.

The reflection optical axis of the mirror 36, the reflection optical axis of the reflecting prism 37, and the reflection optical axis of the first reflective surface 17a are included in the emission optical axis 32. The extended line of the emission optical axis 32 passing through the second reflective surface 17b is referred to as emission optical axis 32′. This emission optical axis 32′ coincides with the reference optical axis of a target 55, described later.

The receiving optical system has a receiving optical axis 41. The distance-measurement-light receiving portion 29 includes, in order from the receiving side, a light-receiving element 39 disposed on the receiving optical axis 41, a receiving prism 42, and a receiving lens 43.

The receiving prism 42 has a dichroic coating 44 as a separating surface for separating reflected distance-measurement light 45 and reflected tracking light 46. The dichroic coating 44 has optical properties that reflect the reflected distance-measurement light 45 and transmit the reflected tracking light 46.

The receiving optical system is constituted by the receiving prism 42, the receiving lens 43, the reflecting prism 37, the scanning mirror 17 (i.e., the first reflective surface 17a), and the like. The receiving optical axis 41 includes the optical axis passing through the receiving prism 42 and the optical axis reflected by the dichroic coating 44.

The emission optical system and the receiving optical system share some components, for example the reflecting prism 37, the scanning mirror 17, and so forth. Additionally, the receiving optical axis 41 shares part of the emission optical axis 32.

The distance-measurement light emitted from the light-emitting element 33 passes through the emission optical system and is reflected by the first reflective surface 17a to be emitted onto the measurement object. The distance-measurement light reflected by the measurement object enters the scanning mirror 17, is reflected by the first reflective surface 17a, and is received by the light-receiving element 39 via the receiving optical system.

Based on control of the distance measurement portion 23 by the calculation/control unit 21, the calculation/control unit 21 measures the distance to the measurement object by determining the emission timing of the light-emitting element 33, the reception timing of the light-receiving element 39, and the speed of light. Moreover, using the result of the distance measurement and the horizontal-angle detection result from the horizontal angle encoder 12, as well as the vertical-angle detection result from the vertical angle encoder 16, the calculation/control unit 21 calculates three-dimensional data of the measurement object.

The tracking-light emission portion 28 includes a tracking light-emitting element 48 and a tracking emission lens 49 in that order from the emission side, and further includes the emission optical system. The tracking light-emitting element 48 is, for example, a laser diode (LD) that emits the tracking light having a different wavelength from the distance-measurement light.

The tracking-light receiving portion 30 includes a tracking light-receiving element 52 and the receiving optical system. The tracking light-receiving element 52 is a CCD or CMOS sensor formed of an array of pixels, and the position of each pixel on the tracking light-receiving element 52 can be identified.

Under control of the calculation/control unit 21, the tracking section emits the tracking light from the tracking light-emitting element 48 to the measurement object via the emission optical system. The tracking light reflected by the measurement object is received by the tracking light-receiving element 52 via the receiving optical system. The calculation/control unit 21 controls tracking based on the reception position of the reflected tracking light 46 on the tracking light-receiving element 52.

Next, the rotation unit 18 will be described.

The rotation unit 18 includes the scanning mirror 17, which has reflective surfaces on both sides. Hereinafter, the surface facing the distance measurement portion 23 is referred to as the first reflective surface 17a, and the rear surface is referred to as the second reflective surface 17b.

The rotation unit 18 has a first window 53 facing the first reflective surface 17a and a second window 54 facing the second reflective surface 17b. The first window 53 and the second window 54 are each formed of a transparent material. The first window 53, the second window 54, and the scanning mirror 17 are structured to rotate integrally.

The first window 53 and the second window 54 are disposed with a predetermined angle of inclination relative to the optical axis of the emission optical axis 32 such that distance-measurement light reflected by these windows 53, 54 does not enter the distance measurement portion 23.

The scanning mirror 17 rotates about the axis 13a, and this axis 13a coincides with the emission optical axis 32. The point at which the emission optical axis 32 intersects the first reflective surface 17a is the instrument center C. The measurement values obtained by the distance measurement portion 23 are based on this instrument center C.

The rotation unit 18 has a target 55 indicating the instrument center C.

The target 55 provides a retroreflective function for light rays entering it. The target 55 is composed of the second reflective surface 17b and an optical member 56 disposed opposite the second reflective surface 17b. The optical member 56 has a retroreflective characteristic and has an optical center O. Further, a virtual image of the optical member 56 is formed by the second reflective surface 17b, and an optical center O′ of this virtual image is formed at a position symmetrical to the optical center O with respect to the second reflective surface 17b.

Light entering the target 55 is reflected by the second reflective surface 17b, enters the optical member 56, is retroreflected therein, and is reflected again by the second reflective surface 17b.

Accordingly, light that enters and is reflected by the target 55 is equivalent to light retroreflected about the optical center O′. Therefore, the target 55 has a retroreflective function, and the optical center O′ is defined as the target center of the target 55 as its optical center (hereinafter referred to as the target center O′).

In the embodiment shown in FIG. 3, the optical member 56 is illustrated as a corner cube 56′. However, the optical member 56 only needs to have a retroreflective characteristic and is not limited to the corner cube 56′. For example, the optical member 56 may be composed of multiple mirrors, a retroreflective sheet, or an optical member having a spherical reflective surface, any of which have a retroreflective characteristic. In the following, for convenience, the optical member 56 is described as the corner cube 56′.

In a case where an incoming light ray enters the second window 54 and is retroreflected by the target 55, it is first reflected by the second reflective surface 17b, then enters the corner cube 56′, is retroreflected therein, and is reflected again by the second reflective surface 17b before exiting through the second window 54.

In the present embodiment, the target center O′ is provided so as to coincide or substantially coincide with the instrument center C. Namely, the second reflective surface 17b, the corner cube 56′, and their relative positions and angles are set such that the target center O′ coincides or substantially coincides with the instrument center C.

It goes without saying that, as a prism having a retroreflective characteristic, aside from a corner cube (with three mutually orthogonal reflection faces, i.e., 90°/90°/90°), arrangements in which the three reflection faces form angles of 90°/90°/90°/n (n being a natural number) or 90°/60°/45° can also be used as the optical member 56.

The surveying device 1 is capable of performing measurement as a laser scanner, and measurement as a total station.

First, in measurement as a laser scanner, the calculation/control unit 21 emits distance-measurement light as pulsed light from the distance-measurement-light emission portion 27, emits the pulsed light onto the measurement object via the emission optical system, and receives reflection from the measurement object via the receiving optical system to perform distance measurement for each pulse of the emitted light. In addition, for each emitted pulse, the calculation/control unit 21 acquires a horizontal angle from the detection result of the horizontal angle encoder 12 and a vertical angle from the detection result of the vertical angle encoder 16, thereby calculating three-dimensional data for the measurement object on a pulse-by-pulse basis.

Furthermore, the calculation/control unit 21 drives the vertical rotation motor 15 to rotate the scanning mirror 17 about the vertical rotation shaft 13, while rotating the surveying-device main body 4 about the horizontal rotation shaft 8 by means of the horizontal rotation motor 11, thus acquiring 360° of point cloud data around the axis of the horizontal rotation shaft 8.

In measurement as a total station, the calculation/control unit 21 rotates the scanning mirror 17 such that the emission axis from the scanning mirror 17 is oriented horizontally (i.e., rotated 90° from the position shown in FIG. 3), and with the distance-measurement light collimated toward the measurement object, it obtains the distance to the measurement object, the horizontal angle, and the vertical angle, thereby calculating three-dimensional coordinates of the measurement object.

Next, a description is given of measuring the installation position of the surveying device 1.

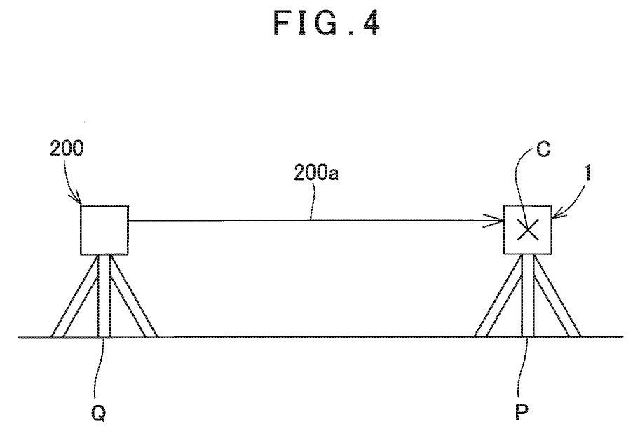

With reference to FIG. 4, a case is explained in which, when the surveying device 1 is set up at an unknown position, another surveying device 200 installed at a known position measures the installation position of the surveying device 1.

In FIG. 4, the surveying device 1 is set up at an unknown setup point P. Another surveying device 200 is set up at a known point Q (or a point made known, hereinafter referred to simply as the known point Q).

An operator or user directs the main body 4 of the surveying device 1 toward the surveying device 200 and aligns the emission optical axis 32′ (the reference optical axis of the target 55) of the rotation unit 18 such that it faces the surveying device 200, then holds it still in that state. In this condition, the rotation unit 18 is rotated 90° from the state illustrated in FIG. 3 such that the emission optical axis 32′ is horizontal.

The surveying device 200 emits distance-measurement light 200a toward the surveying device 1 in order to measure the installation position of the surveying device 1.

The distance-measurement light 200a passes through the second window 54 and enters the target 55. The distance-measurement light 200a retroreflected by the target 55 is received by the surveying device 200, thereby enabling the position of the surveying device 1 to be measured.

The position measured by the surveying device 200 is that of the target center O′ of the target 55, and this target center O′ coincides with the instrument center C.

Accordingly, the surveying device 200 measures the position of the target center O′, and since the target center O′ coincides with the instrument center C of the surveying device 1, it is possible to measure accurately the installation position of the surveying device 1. The setup point P thus becomes known.

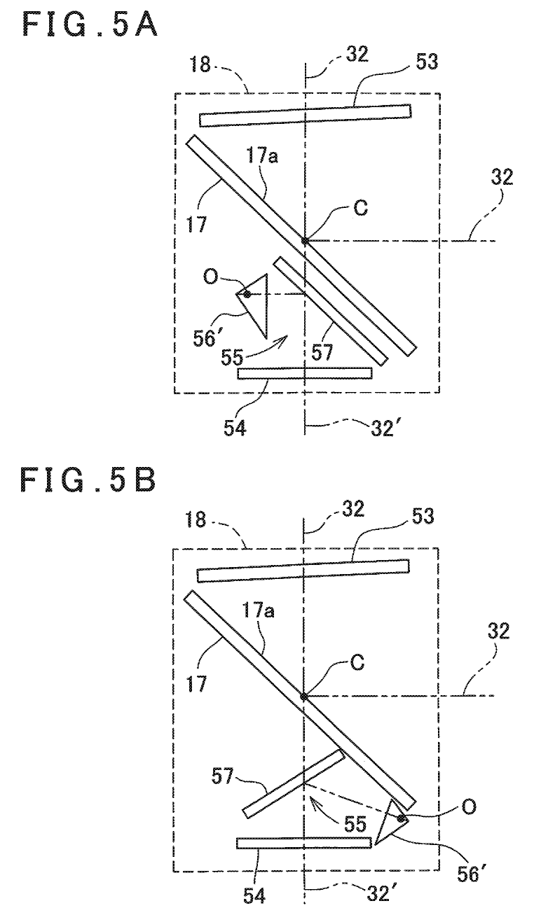

FIG. 5A shows a second embodiment. For simplicity of explanation, only the rotation unit 18 is illustrated. In the figure, elements corresponding to those in FIG. 3 bear the same reference numerals, and their description is omitted. The same applies to the following embodiments.

In the first embodiment described above, the scanning mirror 17 has two reflective surfaces formed by its front and back surfaces. In the second embodiment, instead of using the second reflective surface 17b on the rear side of the scanning mirror 17, a separate mirror 57 is provided.

A surface of the mirror 57 facing the second window 54 serves as a reflective surface. In the second embodiment, the target 55 is formed by this reflective surface and the corner cube 56′ serving as the optical member 56. The reflective surface forms a virtual image of the optical center O of the corner cube 56′ i.e., the target center O′ of the target 55 at the position of the instrument center C.

By providing the mirror 57, the scanning mirror 17 can be made thinner, reducing the weight of the rotation unit 18. Furthermore, there is increased freedom in positioning the corner cube 56′.

In the illustrated example, the reflective face of the mirror 57 is parallel (inclined at 45° with respect) to the emission optical axis 32′, just as the first reflective surface 17a is. However, it is not strictly necessary for these surfaces to be parallel. What is important is that the position of the target center O′ formed by the mirror 57 coincides or substantially coincides with the instrument center C.

FIG. 5B shows a modification of the second embodiment. In the modification, the orientation of the reflective surface of the mirror 57 with respect to the emission optical axis 32′ has been changed. In FIG. 5B, the reflection optical axis of the emission optical axis 32′ is oriented toward the lower end of the scanning mirror 17, and the target 55, which is formed by the reflective surface and the corner cube 56′, is disposed near the lower portion of the scanning mirror 17.

Even in this modification, it suffices that the position of the target center O′ formed by the mirror 57 coincides or substantially coincides with the instrument center C, without any strict limitation on the installation angle of the mirror 57 with respect to the emission optical axis 32′.

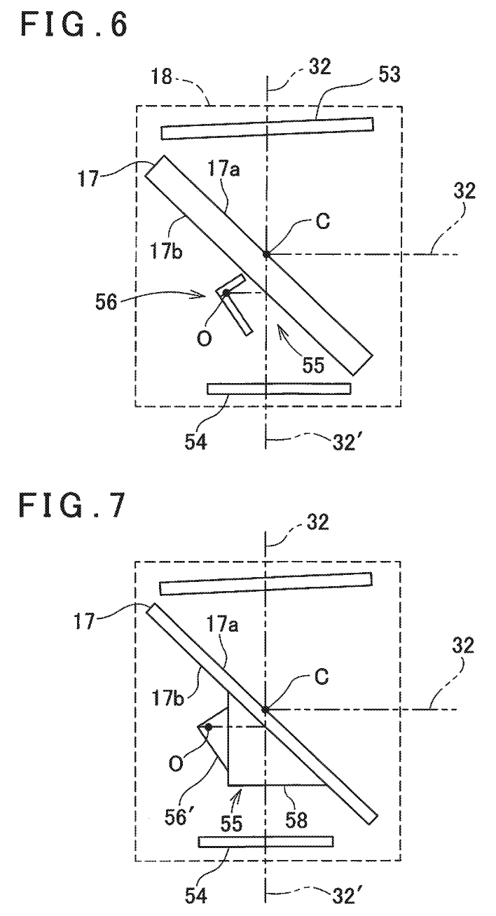

FIG. 6 shows a third embodiment. In the third embodiment, the optical member 56 used in the first embodiment is replaced with three mirrors to realize a retroreflective characteristic. It goes without saying that even in the third embodiment, the target 55 is provided such that the position of the target center O′ coincides with the instrument center C.

A mirror that realizes a retroreflective characteristic is not limited to three orthogonal reflecting faces; mirrors disclosed in Patent Document 4 can also be applied.

FIG. 7 shows a fourth embodiment. In the fourth embodiment, the corner cube 56′ is used as the optical member 56, and the corner cube 56′ is attached to the rear surface (the second reflective surface 17b) of the scanning mirror 17 via a triangular prism 58 serving as a deflection prism.

In the fourth embodiment, a surface of the triangular prism 58 that is joined to the rear surface of the scanning mirror 17 serves as a reflective surface. The target 55 is formed by this reflective surface and the corner cube 56′.

The corner cube 56′ is disposed on the reflection optical axis of the reflective surface. Needless to say, the target 55 is arranged such that the virtual image of the optical center O of the corner cube 56′, namely the target center O′, coincides with the instrument center C. Note that the triangular prism 58 may be joined to the second reflective surface 17b or may be disposed separately from the second reflective surface 17b.

Also, in the figure, the deflection angle at the corner cube 56′ is shown as 90°, but it is not limited to 90°. In this embodiment, it is possible to widen the corner cube 56′, and the scanning mirror 17 can be made thinner, which is advantageous.

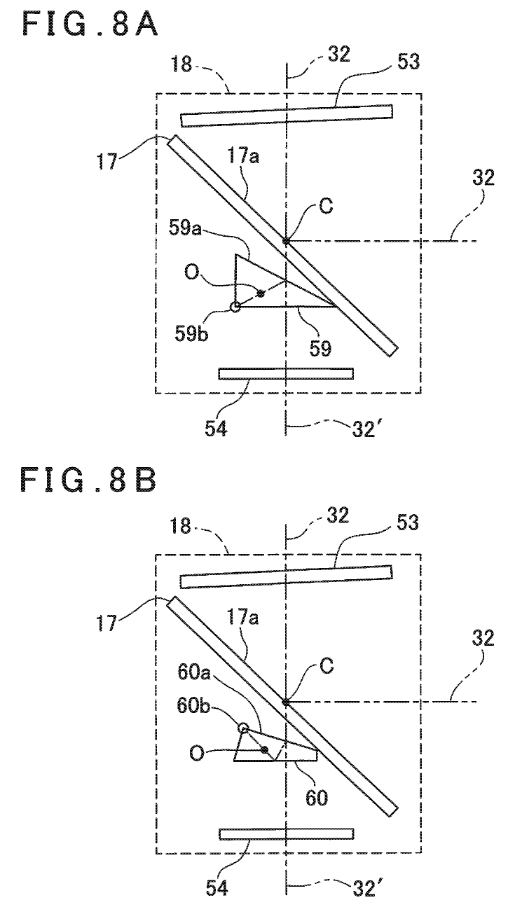

FIG. 8A shows a fifth embodiment. In the fifth embodiment, a deflecting corner-cube prism 59 is disposed, with a gap, opposite the rear surface of the scanning mirror 17.

The deflecting corner-cube prism 59 forms a vertex 59b of the corner cube, has three faces that produce retroreflection, and includes a deflection reflective surface 59a that deflects incoming light rays toward those three reflective faces that produce retroreflection. The deflection reflective surface 59a forms a virtual image of the optical center O at the instrument center C, and it functions equivalently to the second reflective surface 17b of the scanning mirror 17. In the fifth embodiment, the deflecting corner-cube prism 59 which has both a reflective surface and a corner-cube portion functioning as the optical member 56 serves as the target.

The deflection reflective surface 59a of the deflecting corner-cube prism 59 faces the rear surface of the scanning mirror 17. Distance-measurement light that enters along the emission optical axis 32′ is reflected by the deflection reflective surface 59a, then retroreflected by the corner-cube portion, and is emitted along the emission optical axis 32′ via the deflection reflective surface 59a once again. In FIG. 8A, the corner-cube portion is formed by three faces contributing to retroreflection.

In the fifth embodiment, the deflecting corner-cube prism 59 integrates the corner cube 56′ of the fourth embodiment and the triangular prism 58 (hereinafter, a prism that integrates a deflection prism and a corner cube is referred to as a deflecting corner-cube prism), thus making it possible to reduce weight.

FIG. 8B shows a modification of the fifth embodiment. In this modification, a deflecting corner-cube prism 60 is configured such that the light path from incidence to the corner-cube portion (where 60b denotes the vertex of the corner-cube portion) includes multiple reflections (two reflections in the illustrated example). By means of the deflection reflective surface 60a facing the scanning mirror 17, a virtual image of the optical center O of the deflecting corner-cube prism 60 is formed at the position of the instrument center C, thereby defining the target center O′.

In the deflecting corner-cube prism 60 of the present embodiment, further miniaturization is possible.

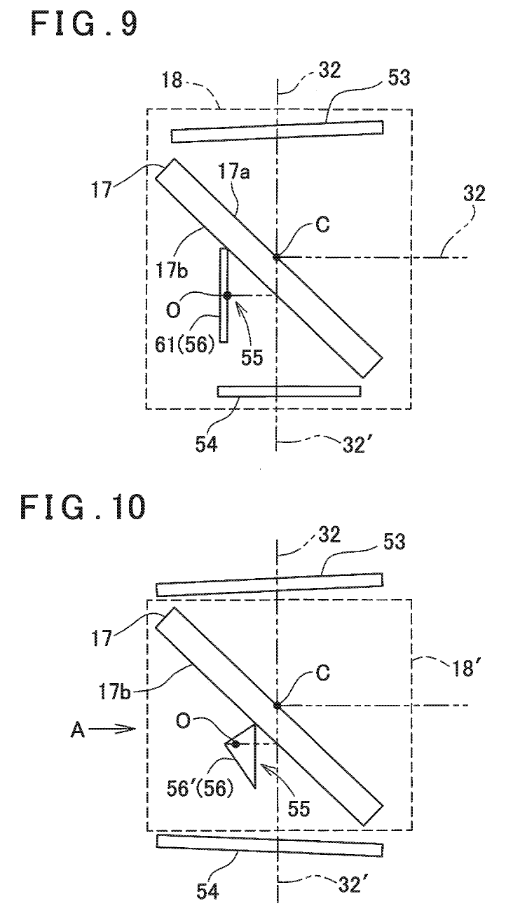

FIG. 9 shows a sixth embodiment. In this sixth embodiment, the optical member 56 having a retroreflective characteristic is realized by a retroreflective sheet 61. The center of the retroreflective sheet 61 is regarded as the optical center O, and the second reflective surface 17b forms a virtual image of the optical center O at the position of the instrument center C. The second reflective surface 17b and the retroreflective sheet 61 constitute the target 55.

The sixth embodiment is an example in which, in the first embodiment, the corner cube 56′ is replaced with the retroreflective sheet 61. By using the retroreflective sheet 61, it is possible to produce the device at low cost and with reduced weight.

FIG. 10 shows a seventh embodiment. In the first through sixth embodiments, the rotation unit 18 is configured to include the first window 53 and the second window 54 (see FIG. 3). In the seventh embodiment, however, the first window 53 and the second window 54 are fixed, and the scanning mirror 17 and the target 55 rotate vertically as a rotation unit 18′.

By forming the first window 53 and the second window 54 separately from the rotation unit 18′, the rotation unit 18′ can be made lighter in weight, which is advantageous in a surveying device that rotates the rotation unit at high speed, such as a laser scanner.

Furthermore, the first window 53 and the second window 54 may be integrated into a single window 62 that houses the rotation unit 18′.

FIGS. 11A and 11B each provide an example of a window 62 in which the first window 53 and the second window 54 are integrated, each figure being an elevational view from the direction of arrow A in FIG. 10.

The window 62 is made of a transparent material and, in FIG. 10, has an open shape at its left and right ends. In FIG. 11A, the window 62 is rectangular; in FIG. 11B, the window 62 is cylindrical. It of course may also be conical, spherical, or the like, depending on design choice.

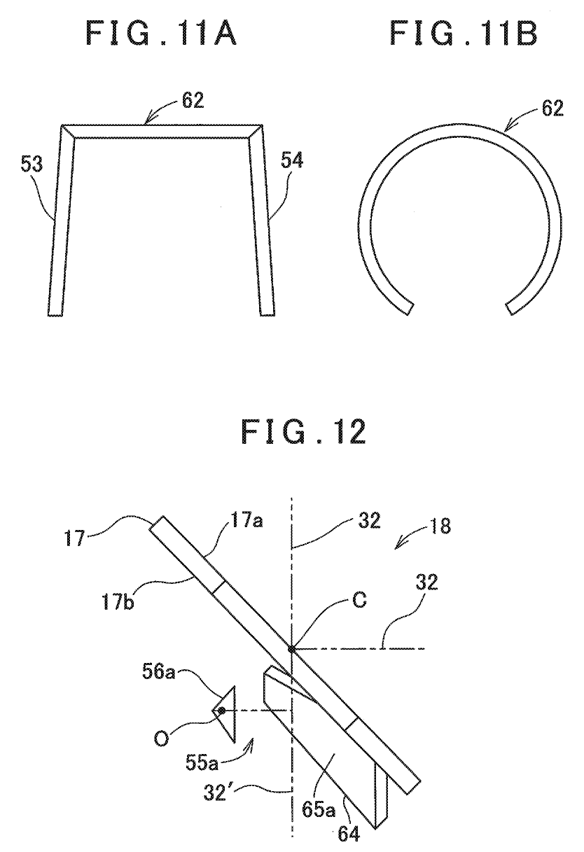

FIGS. 12 to 15 show an eighth embodiment. In FIGS. 12 to 15, components equivalent to those shown in FIG. 5A bear the same reference numerals, and their explanations are omitted.

FIGS. 12 to 15 are views extracting the optical components of the rotation unit 18, and a condition is shown in which the emission optical axis 32 is vertical. For convenience of explanation, the following description also assumes the emission optical axis 32 is vertically oriented.

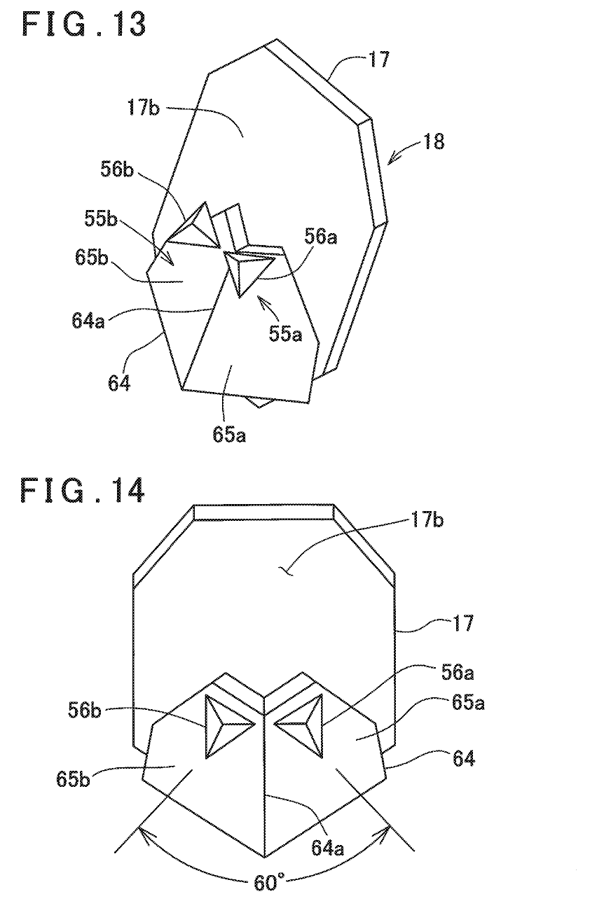

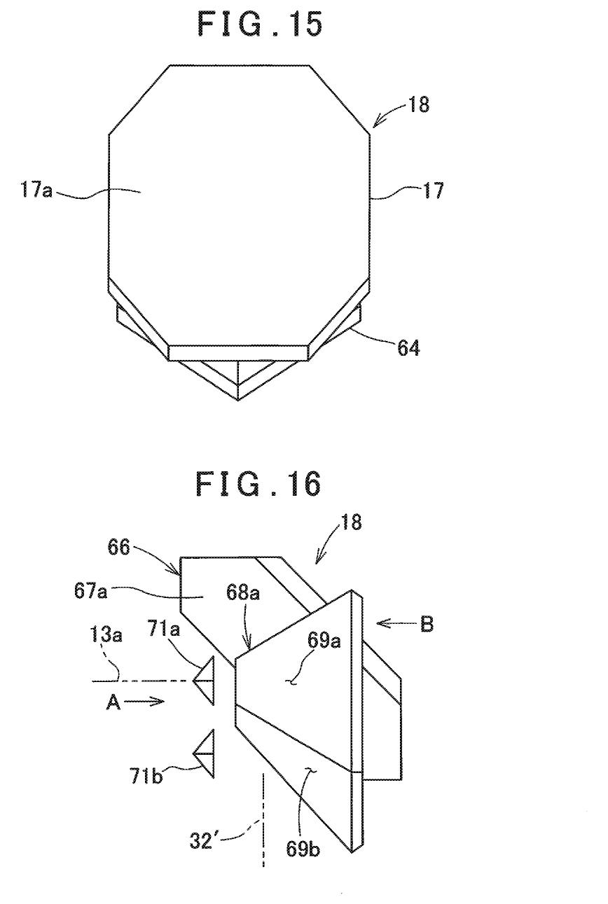

FIG. 12 is a side view, FIG. 13 is a perspective view of the rear-face side (the side of the scanning mirror 17’s back surface), FIG. 14 is a rear view, and FIG. 15 is a front view.

A mirror 64 is disposed opposite the rear surface of the scanning mirror 17. This mirror 64 basically has the same optical effect as mirror 57 in the second embodiment.

The mirror 64 has a chevron-shaped cross section, which includes a ridge line 64a, and two reflective surfaces 65a, 65b sandwiching that ridge line 64a. Corner cubes 56a, 56b are disposed respectively facing these reflective surfaces 65a, 65b.

The angle between the reflective surfaces 65a, 65b is 120°, such that the angle formed by the reference optical axes of the corner cubes 56a, 56b is 60° (see FIG. 14). It goes without saying that this 60° angle is not limiting.

With respect to a vertical plane that includes the ridge line 64a, the shape of mirror 64 and the arrangement of corner cubes 56a, 56b are symmetrical.

In the eighth embodiment, the reflective surface 65a and corner cube 56a, and the reflective surface 65b and corner cube 56b, respectively constitute targets. Accordingly, in the eighth embodiment, two targets 55a and 55b are provided. The target centers of both targets 55a, 55b are made to coincide with the instrument center C.

A description is now given of the reflective surface 65a and the corner cube 56a. As noted above, the reflective surface 65a and the corner cube 56a form the target 55a, and the position of the virtual image of the optical center O of the corner cube 56a, formed by the reflective surface 65a, is the target center O′ of the target 55a.

The mirror 64 (reflective surface 65a) and the corner cube 56a are arranged such that the reflective surface 65a forms the virtual image of the optical center O of the corner cube 56a at the position of the instrument center C. The same applies to the reflective surface 65b and the corner cube 56b.

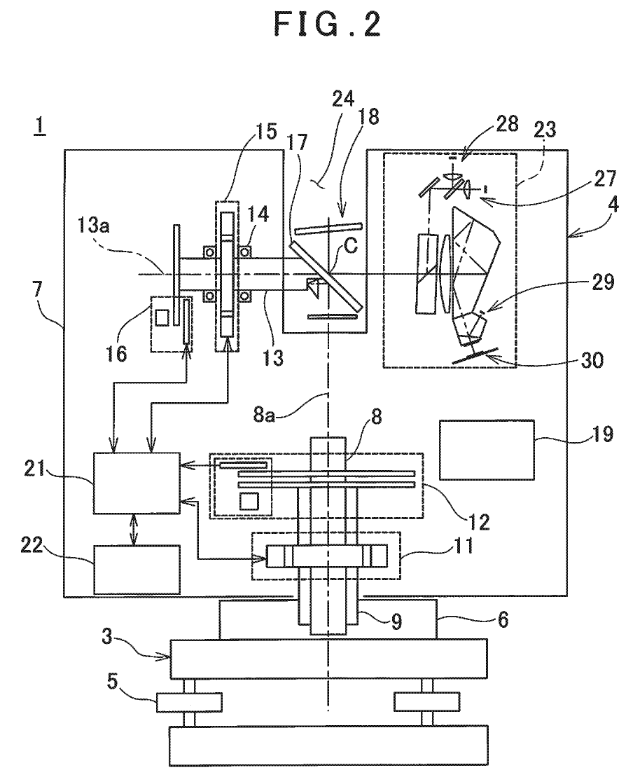

When the surveying device 1 is measured by another surveying device 200 (see FIG. 4), the rotation unit 18 is turned 90° from the state of FIG. 12 about the vertical rotation shaft 13 (see FIG. 2), such that the emission optical axis 32′ is oriented horizontally, and that emission optical axis 32′ faces the surveying device 200.

The distance-measurement light from the surveying device 200 enters the target 55a and is retroreflected. In other words, it enters and is reflected by the reflective surface 65a, then enters the corner cube 56a, is retroreflected by corner cube 56a, and then is reflected again by the reflective surface 65a. Thus, the surveying device 200 measures the position of the target center O′ of the target 55a. Because the position of the target center O′ coincides or substantially coincides with the instrument center C, an accurate measurement of the installation position of the surveying device 1 can be made.

In this state where the surveying device 1 is being measured, the corner cubes 56a, 56b are arranged vertically. In such an arrangement, the combined angular field at which retroreflection occurs with corner cubes alone is about 70° in the horizontal direction for each individual corner cube, but about 140° in total in the vertical direction when adding the fields of corner cubes 56a and 56b. Therefore, in the eighth embodiment, retroreflection is possible over a wider angular field. Note that the specific mention of 70° horizontally and 140° vertically are merely examples and are not limiting.

FIGS. 16 to 20 illustrate a ninth embodiment. These drawings extract the optical components of the rotation unit 18 in a condition where the emission optical axis 32′ is vertical. For convenience of explanation, the following description likewise assumes the emission optical axis 32′ is vertically oriented.

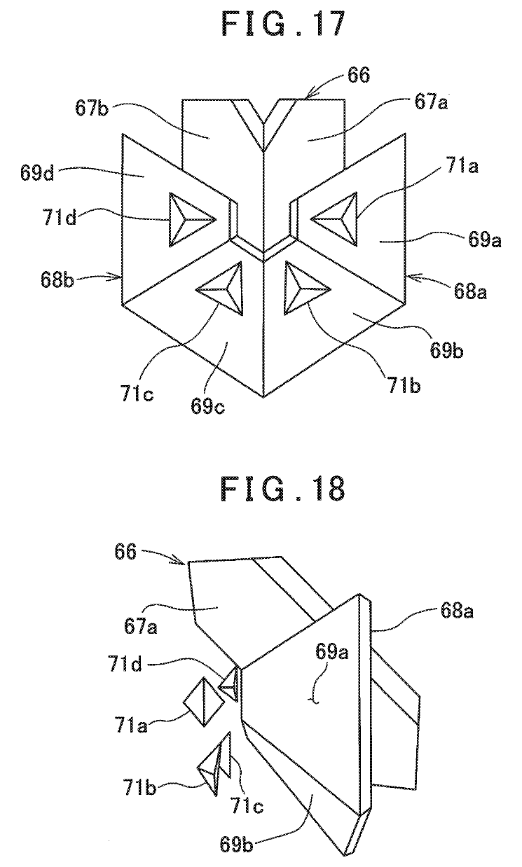

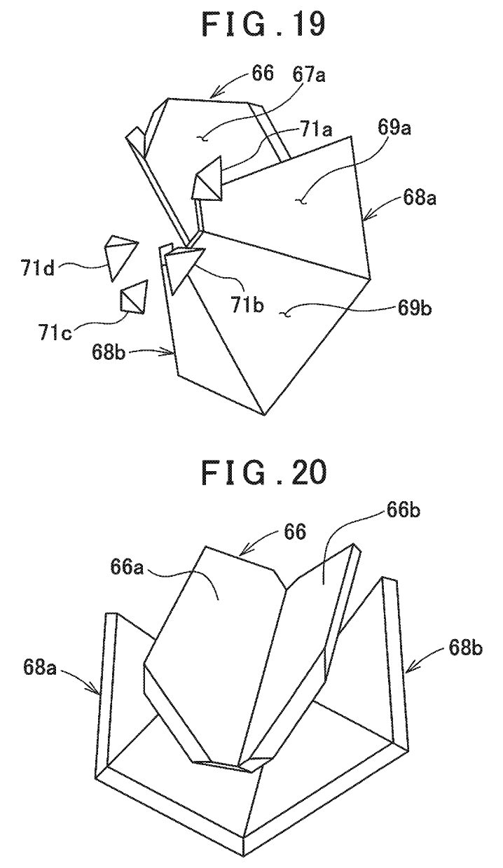

FIG. 16 is a side view; FIG. 17 is a view in the direction of arrow A of FIG. 16; FIG. 18 is a perspective view of FIG. 16; FIG. 19 is a perspective view in the direction of arrow A of FIG. 16; and FIG. 20 is a perspective view in the direction of arrow B of FIG. 16.

The ninth embodiment is an example in which the scanning mirror 17 is replaced with a scanning mirror 66 that has a Dach reflecting surface. The scanning mirror 66 has reflective surfaces on both the front and back sides.

The reflective surfaces of the scanning mirror 66 facing the distance-measurement portion 23 (see FIG. 3) are defined as inside Dach reflecting surfaces 66a, 66b, and the reflective surfaces on the rear side are defined as outside Dach reflecting surfaces 67a, 67b.

Mirrors 68a, 68b are disposed opposite the outside Dach reflecting surfaces 67a, 67b. In the illustration, the mirrors 68a and 68b are shown as a single integrated unit, but they may be separate and provided individually.

Because the mirrors 68a, 68b are of the same shape and have the same optical function, the following description focuses on the mirror 68a; elements having the same function are given the same reference numerals.

The mirror 68a has the same general function as the mirror 64 in the eighth embodiment.

The mirror 68a has a chevron-shaped cross section and two reflective surfaces 69a, 69b sandwiching a ridge line. Corner cubes 71a, 71b are disposed facing these reflective surfaces 69a, 69b.

The mirror 68a (reflective surface 69a) and the corner cube 71a are arranged such that, by means of reflective surface 69a, the virtual image of the optical center O of the corner cube 71a is formed at the position of the instrument center C that is, the target center O′ is formed at the position of the instrument center C. The same arrangement applies to reflective surface 69b and corner cube 71b.

The same is true of mirror 68b, which has reflective surfaces 69c, 69d; corner cubes 71c, 71d are disposed facing these reflective surfaces 69c, 69d, respectively.

The corner cubes 71a, 71b, 71c, 71d are disposed so as to be spaced at 60° intervals along the same circumference.

In the ninth embodiment, four targets are formed: one each by the reflective surface 69a and corner cube 71a, by the reflective surface 69b and corner cube 71b, by the reflective surface 69c and corner cube 71c, and by the reflective surface 69d and corner cube 71d.

When the emission optical axis 32′ of the rotation unit 18 is set horizontally, the combined angular field with corner cubes 71a, 71b, 71c, 71d is about 70° horizontally and about 260° vertically, enabling retroreflection of distance-measurement light over an even wider angular range. That is, the position of the surveying device 1 can be measured from a wide variety of directions by another surveying device 200. Note that the mention of about 70° horizontally and about 260° vertically is illustrative, and these angles are determined by the optical characteristics of the corner cubes 71 and are thus not limiting.

When measuring the installation position of the surveying device 1, the rotation unit 18 is set such that the emission optical axis 32′ is horizontal, and this emission optical axis 32′ is directed toward the other surveying device 200. Distance-measurement light emitted from the other surveying device 200 enters one of the reflective surfaces 69a, 69b, 69c, or 69d and is retroreflected by the corner cube 71 disposed opposite the reflective surface into which the light entered. The other surveying device 200 receives the reflected light and measures the surveying device 1 accordingly.

After the surveying device 1 is thus measured, when the surveying device 1 itself subsequently performs measurement, it emits distance-measurement light from the distance-measurement portion 23, which is reflected by the inside Dach reflecting surfaces 66a, 66b of the scanning mirror 66. As the rotation unit 18 is rotated vertically, the scanning mirror 66 is turned, such that the distance-measurement light reflected by the scanning mirror 66 is emitted in sweeping fashion, providing for distance measurement.

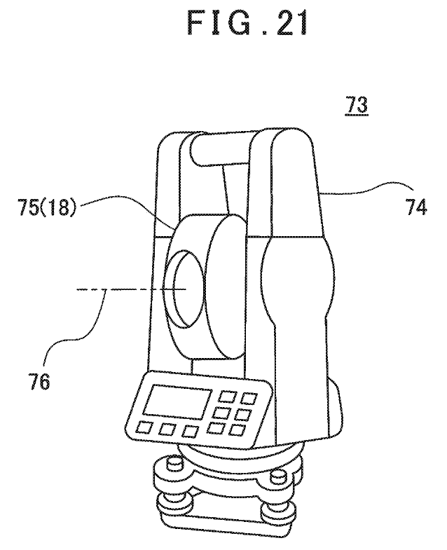

FIGS. 21 to 23 show a tenth embodiment.

The tenth embodiment illustrates the application of the present disclosure to a total station.

FIG. 21 shows the external appearance of a total station 73, where 74 is a support portion, 75 is a telescope portion, 76 is a collimation optical axis, and C indicates the instrument center (measurement reference point).

The telescope portion 75 houses the optical system 77 of the surveying device 1. The telescope portion 75 is supported by the support portion 74 so as to be rotatable in the vertical direction about a horizontal axis, functioning as a rotation unit 18. The optical system 77 includes, in addition to the telescope optical system, a emission/tracking optical system 85, a receiving optical system 86, and a target 55.

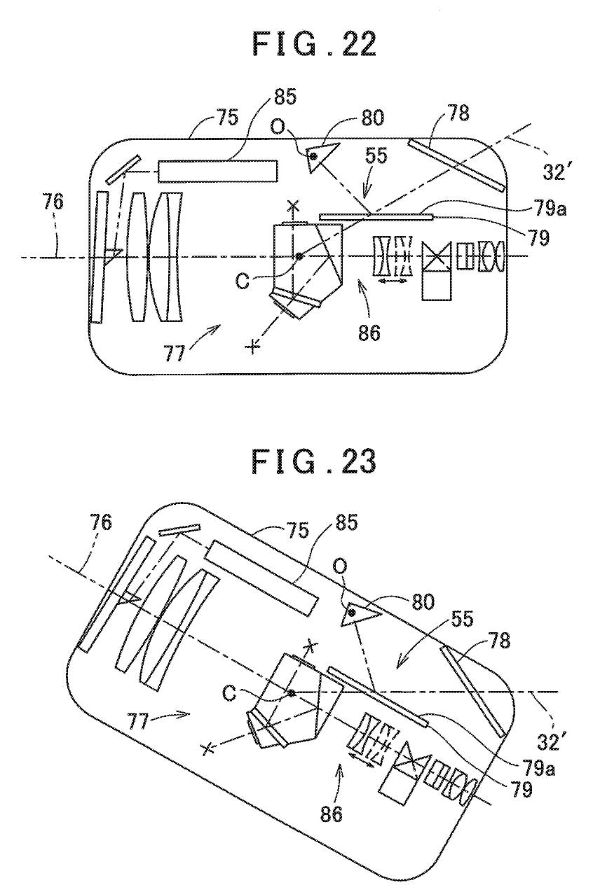

FIG. 22 is a schematic diagram of the telescope portion 75.

A window 78 is provided at an appropriate position in the telescope portion 75, and the window 78 is sealed liquid-tight with a transparent material such as a glass plate or synthetic resin plate.

The optical axis passing through the instrument center C and the window 78 is referred to as the emission optical axis 32'. A mirror 79 is provided at a position on the emission optical axis 32' where it does not interfere with the optical system 77.

A corner cube 80 is provided on the reflected optical axis of the emission optical axis 32' by the mirror 79. The corner cube 80 has an optical center O, and the position of the virtual image of the optical center O formed by the reflective surface 79a of the mirror 79 is set to coincide with the position of the instrument center C by adjusting the positions of the corner cube 80 and the window 78.

In the tenth embodiment, the target 55 is constituted by the reflective surface 79a and the corner cube 80, and the position of the target center O' of the target 55 coincides with the position of the virtual image of the optical center O.

FIG. 23 shows the state of the total station 73 when its position is measured by another surveying device 200.

When measuring the position of the total station 73, the telescope portion 75 is rotated such that the emission optical axis 32' is horizontal or faces the surveying device 200.

The distance-measurement light from the surveying device 200 enters through the window 78, is reflected by the mirror 79, and enters the corner cube 80. The reflected distance-measurement light retroreflected by the corner cube 80 is received and measured by the surveying device 200 via the mirror 79 and the window 78.

What is measured by the surveying device 200 is the position of the optical center O of the corner cube 80, that is, the target center O'. Since the position of the target center O' coincides or substantially coincides with the instrument center C, the position of the total station 73 can be measured accurately.

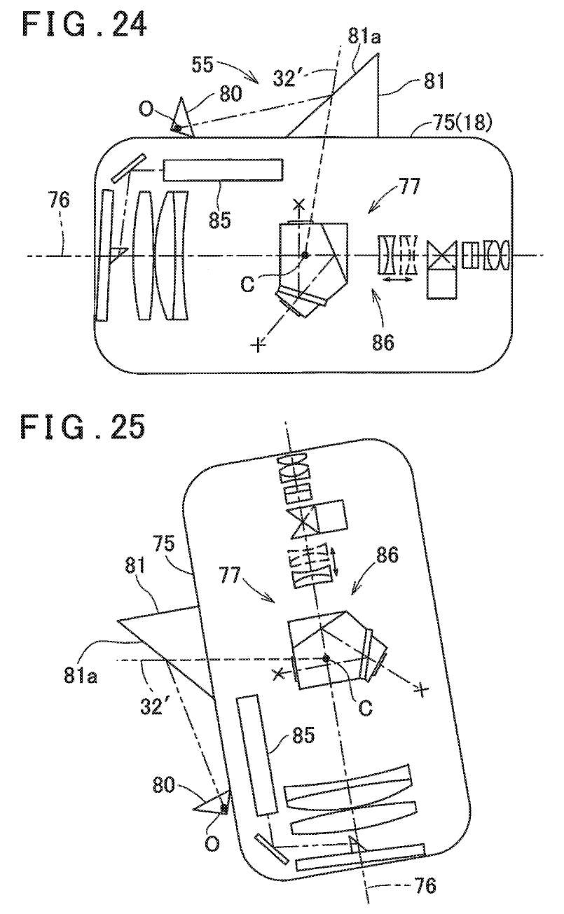

FIGS. 24 to 26 describe an eleventh embodiment.

The eleventh embodiment illustrates the application of the present disclosure to a total station.

In FIGS. 24 to 26, components equivalent to those shown in FIGS. 21 to 23 are denoted by the same reference numerals, and their explanations are omitted.

A reflective prism 81 having a reflective surface 81a is provided on the upper surface of the telescope portion 75. The reflective prism 81 is provided on the emission optical axis 32' passing through the instrument center C, and a corner cube 80 is provided facing the reflective surface 81a. The corner cube 80 is provided on the reflected optical axis of the emission optical axis 32' reflected by the reflective prism 81.

The target 55 is constituted by the reflective surface 81a and the corner cube 80.

The reflective surface 81a forms a virtual image of the optical center of the corner cube 80. The position of the virtual image is set so as to coincide with the instrument center C by adjusting the position and reflection angle of the reflective prism 81 and the position of the corner cube 80. The position of the virtual image is the position of the target center O', and the target 55 is provided such that the target center O' coincides or substantially coincides with the instrument center C.

In the eleventh embodiment, when the position of the surveying device 1 is measured by another surveying device, the telescope portion 75 is rotated vertically such that the emission optical axis 32' becomes the position of the collimation optical axis 76 (i.e., the emission optical axis 32' faces the direction of the other surveying device).

The distance-measurement light from the other surveying device is reflected by the reflective prism 81, further retroreflected by the corner cube 80, and the reflected light is received by the other surveying device. Thus, the optical center O of the corner cube 80 is measured. Since the position of the optical center O is equivalent to the instrument center C, the instrument center C can be measured accurately.

It goes without saying that the reflective prism 81 may be replaced with an optical member such as a mirror having a reflective surface equivalent to the reflective surface 81a.

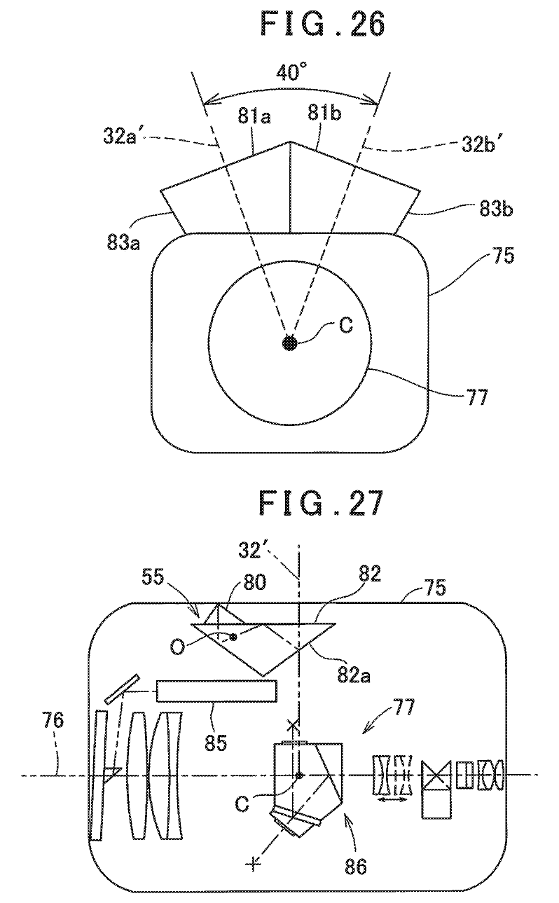

FIG. 26 shows a modification of the eleventh embodiment.

This modification shows an example in which two reflective prisms 83a and 83b are provided side by side in the horizontal direction on the upper surface of the telescope portion 75, with the collimation optical axis 76 collimating in the horizontal direction. The reflective prisms 83a and 83b are manufactured such that the emission optical axes 32a' and 32b' of the respective prisms both pass through the instrument center C. In the illustration, the angle formed by the emission optical axes 32a' and 32b' is 40°, but this angle is not limited to 40°. Further, three or more reflective prisms may be provided, with each emission optical axis set to pass through the instrument center C.

By providing multiple reflective prisms, a wide angle for retroreflection can be achieved. For example, in this embodiment, measurement of the surveying device 1 is possible over a range of approximately 80° in the horizontal direction.

Moreover, in this embodiment, since the reflective prism 81 and the corner cube 80 can be retrofitted to the telescope portion 75, processing of the telescope portion 75 is unnecessary, and the invention can be implemented on existing surveying devices.

Furthermore, the reflective prism 81 and the corner cube 80 may be integrated into a case (not shown) to constitute a target unit. In this case, the target unit has the target center O' outside the target unit, and the target unit may be attached to the telescope portion 75 such that the target center O' coincides with the instrument center C of the telescope portion 75. By unitizing the reflective prism 81 and the corner cube 80, handling is improved, and retrofitting to the telescope portion 75 is easy without requiring processing.

FIG. 27 shows a twelfth embodiment.

In FIG. 27, components equivalent to those shown in FIGS. 21 to 23 are denoted by the same reference numerals, and their explanations are omitted.

In the twelfth embodiment, a corner cube 80 integrated with a reflective prism 82 is provided near the optical system 77 at a position where it does not interfere with the optical action of the optical system 77.

The reflective prism 82 is provided on the emission optical axis 32' passing through the instrument center C, and a light ray incident along the emission optical axis 32' is internally reflected twice by the reflective prism 82 and enters the corner cube 80, where it is retroreflected.

The position of the virtual image of the optical center O formed by the reflective surface 82a of the reflective prism 82 is adjusted so as to coincide or substantially coincide with the position of the instrument center C. In the target 55 shown in the twelfth embodiment, the corner cube 80 and the reflective surface 82a are included.

In the twelfth embodiment, since the integrated reflective prism 82 and corner cube 80 function as the target 55, the target 55 can be provided after adjustment of the optical system 77 is completed, improving workability.

In the illustration, the emission optical axis 32' is orthogonal to the collimation optical axis 76. However, as long as the position of the virtual image of the optical center O coincides with the instrument center C, the emission optical axis 32' and the collimation optical axis 76 need not be orthogonal. Furthermore, the reflective prism 82 may be configured to perform one, two, or three internal reflections, and is not limited to two internal reflections.

In the twelfth embodiment, when the surveying device 1 is measured by another surveying device, it is sufficient to rotate 90° counterclockwise from the state shown in FIG. 27.

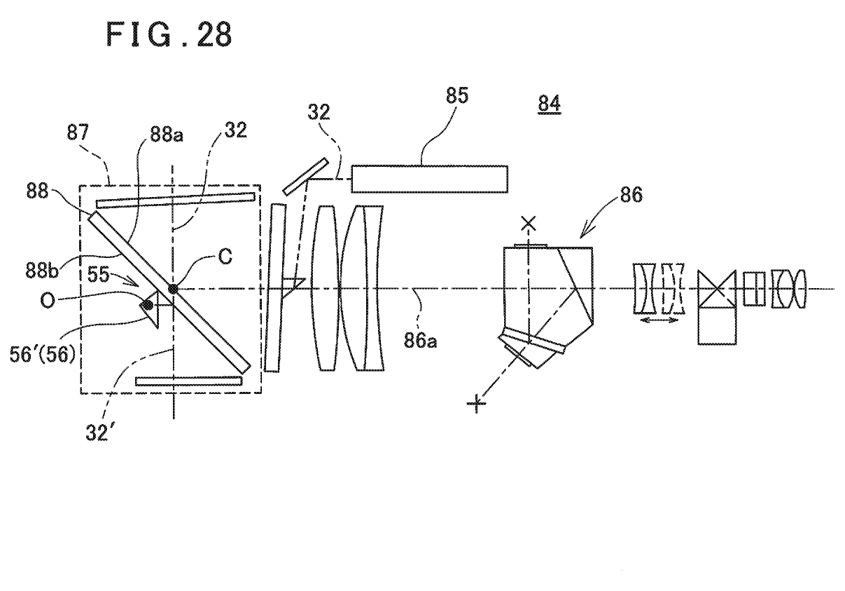

FIG. 28 shows a thirteenth embodiment.

The thirteenth embodiment illustrates the application of the present disclosure to a total station 84.

The total station 84 has a common rotation unit 87 for the emission/tracking optical system 85 and the receiving optical system 86, and is configured to emit distance-measurement light and tracking light via the rotation unit 87, and to receive reflected distance-measurement light and reflected tracking light via the rotation unit 87. The rotation angle of the emission/tracking optical system 85 is detected by an angle detector such as a vertical angle encoder (see FIG. 2).

The rotation unit 87 is rotatable about the optical axis 86a of the receiving optical system 86, and the rotation unit 87 has a mirror 88 that deflects the emission optical axis 32 of the emission/tracking optical system 85 at a right angle. The mirror 88 has a reflective surface 88a facing the receiving optical system 86 and a reflective surface 88b on the back side of the reflective surface 88a, and the intersection of the reflective surface 88a and the optical axis 86a is the instrument center C. The optical axis 86a is reflected by the mirror 88 to become the emission optical axis 32.

A target 55 is provided on the back side of the mirror 88, and the target 55 is constituted by the reflective surface 88b and the corner cube 56' as the optical member.

A corner cube 56' as the optical member 56 is provided at a position facing the reflective surface 88b. The reflective surface 88b forms a virtual image of the optical center O of the corner cube 56'. The position of the virtual image is the target center O' of the target 55.

The corner cube 56' retroreflects a light ray incident from the emission optical axis 32', which is an extension of the emission optical axis 32. The position of the corner cube 56' is adjusted such that the position of the virtual image coincides with the instrument center C.

When measuring the position of the surveying device 1 by another surveying device, the emission/tracking optical system 85 is rotated such that the emission optical axis 32' faces the other surveying device, and the distance-measurement light from the other surveying device enters the corner cube 56'.

The other surveying device measures the optical center O of the corner cube 56'. Since the optical center O coincides with the instrument center C of the surveying device 1, the position of the surveying device 1 can be measured accurately.

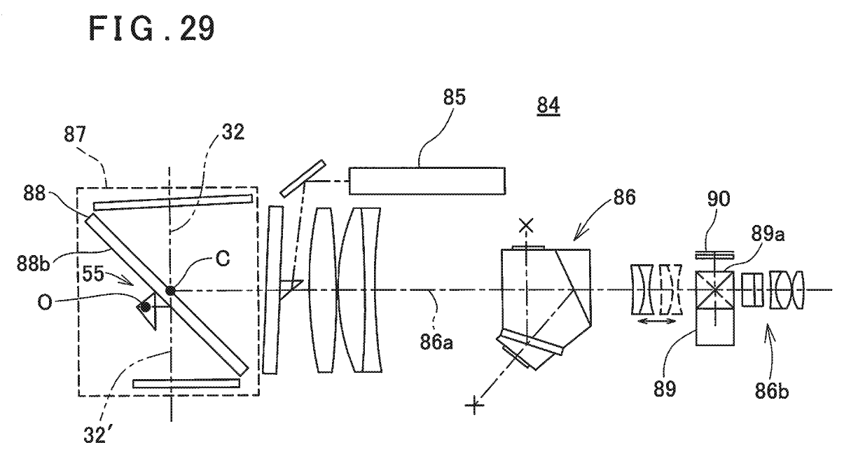

FIG. 29 shows a modification of the thirteenth embodiment. In this modification, a display is provided (not shown in the figure).

The receiving optical system 86 has an eyepiece optical system 86b, allowing visual observation of the measurement target and measurement state during measurement. The eyepiece optical system 86b has a Porro prism 89 to provide an erect image for collimating.

In this embodiment, when the emission optical axis 32 is sighted at the measurement target by rotating the rotation unit 87, the collimated image also rotates with the rotation of the rotation unit 87. Therefore, when the emission optical axis 32 is not horizontal or near horizontal, the collimated image rotates greatly, making it unsuitable for surveying accompanied by collimating.

In this embodiment, one of the prisms constituting the Porro prism 89 is joined with a right-angle prism 89a, and a beam splitter film is formed on the joint surface. The optical characteristics of the beam splitter film are, for example, transmission:reflection = 2:1. The ratio of transmission to reflection is not limited to 2:1 and can be changed as appropriate depending on the state of the device.

An image sensor 90 is provided on the reflective optical axis of the right-angle prism 89a. A CMOS or CCD sensor is used as the image sensor 90. The image data output by the image sensor 90 is input to the calculation/control unit (not shown) of the total station 84. The calculation/control unit processes the image data into an erect image based on the rotation angle of the rotation unit 87 and displays it as a collimated image on the display.

The surveyor can work while viewing the erect image on the display. In this modification, the lens system for direct visual observation may be omitted.

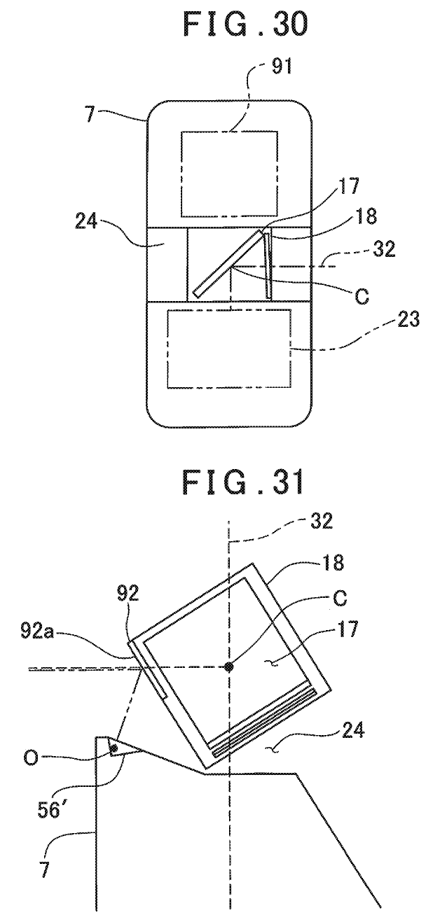

FIGS. 30 and 31 show a fourteenth embodiment in which the present disclosure is applied to a laser scanner. In the above description, the surveying device including a telescope portion housed in the rotation unit 18 was described, but it goes without saying that the invention is also applicable to surveying devices without a telescope portion.

FIG. 30 is a plan view of the surveying device, and FIG. 31 is a side view of the rotation unit 18. In FIG. 30, 23 is a distance-measurement portion, and 91 is a rotation drive unit including a vertical rotation motor 15 (see FIG. 2). In FIGS. 30 and 31, components equivalent to those shown in FIGS. 2 and 3 are denoted by the same reference numerals, and their explanations are omitted.

In FIG. 31, the rotation unit 18 rotates about a rotation axis passing through the instrument center C (perpendicular to the plane of the paper).

A mirror 92 is provided at a predetermined position (excluding the window glass) on the outer surface of the rotation unit 18. A corner cube 56' is provided on the fixed portion facing the rotation unit 18 (in the illustration, the bottom surface of the recess 24 formed in the support portion 7; see FIG. 2).

The positional relationship between the corner cube 56' and the mirror 92 is set such that, when the rotation unit 18 is rotated to a predetermined angle, the distance-measurement light from another surveying device enters the mirror 92, is reflected by the mirror 92, enters the corner cube 56', and is retroreflected. The target is constituted by the corner cube 56' and the reflective surface 92a of the mirror 92, and the position of the virtual image of the optical center O formed by the reflective surface 92a (target center O') is set to coincide with the instrument center C.

The predetermined angle of the rotation unit 18 may be a preset angle, or may be the angle at which the distance-measurement light is retroreflected by the corner cube 56' as the rotation unit 18 is rotated.

The positions where the corner cube 56' and the mirror 92 are provided are not limited to the above embodiments. For example, in the above embodiment, the mirror 92 is provided on the outer surface of the rotation unit 18, but it may be provided inside the rotation unit 18, and the corner cube 56' may be provided on any fixed portion, not limited to the bottom surface of the recess 24. Further, multiple mirrors 92 and corner cubes 56' may be provided.

Alternatively, either or both of the first window portion 53 and the second window portion 54 may be used as a mirror for incident distance-measurement light to the corner cube 56'. In this case, a beam splitter film may be formed on the surface of the first window portion 53 and/or the second window portion 54, with a reflectance of, for example, 0.5 to 20%.

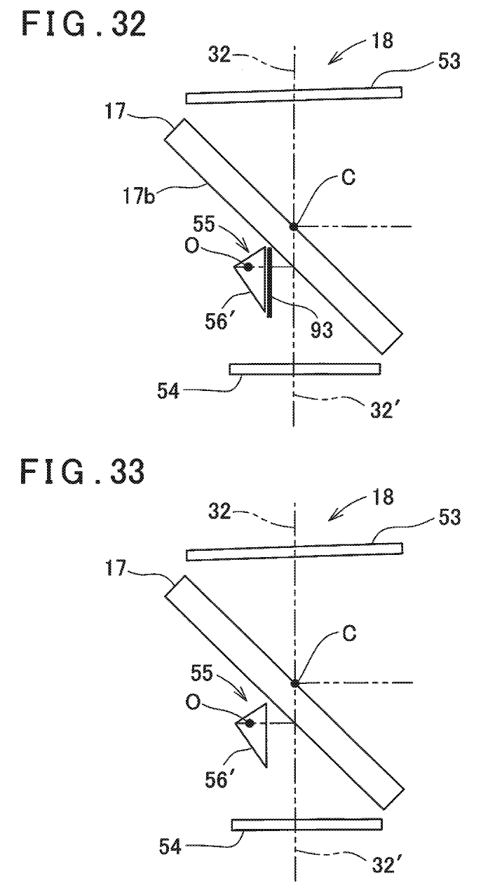

FIG. 32 shows a fifteenth embodiment, extracting the optical member of the rotation unit 18. In FIG. 32, components equivalent to those shown in FIG. 3 are denoted by the same reference numerals, and their explanations are omitted.

When surveying devices equipped with the target 55 do not measure each other, the target 55 may be positioned directly below or above the scanning mirror 17, or at another position to prevent erroneous measurement, such that distance-measurement light from other surveying devices is not retroreflected by the target 55.

Furthermore, in order to prevent retroreflection, a shutter may be provided in the incident optical path to the target 55. The shutter may be a mechanical shutter in which a shielding plate is inserted or removed from the optical path, a liquid crystal shutter that blocks or transmits light by switching the voltage ON/OFF, a shutter using an electrochromic element provided in a transparent body and controlled by voltage applied to the electrochromic element, or a shutter using an electrowetting element provided in a transparent body and controlled by voltage applied to the electrowetting element to move a light-blocking liquid and block or transmit light. Any of these types may be applied.

FIG. 32 shows an example in which a shutter 93 is provided on the front surface of the corner cube 56′ of the target 55. By providing the shutter 93, light incident on the corner cube 56′ can be reliably blocked, thereby preventing erroneous measurement.

FIG. 33 shows a modification of the fifteenth embodiment.

In this modification, the second window 54 facing the corner cube 56′ also serves as a shutter. A liquid crystal shutter, electrochromic element, or electrowetting element is provided in the second window 54, and by voltage control, incident light is blocked when the surveying device 1 is not the measurement target.

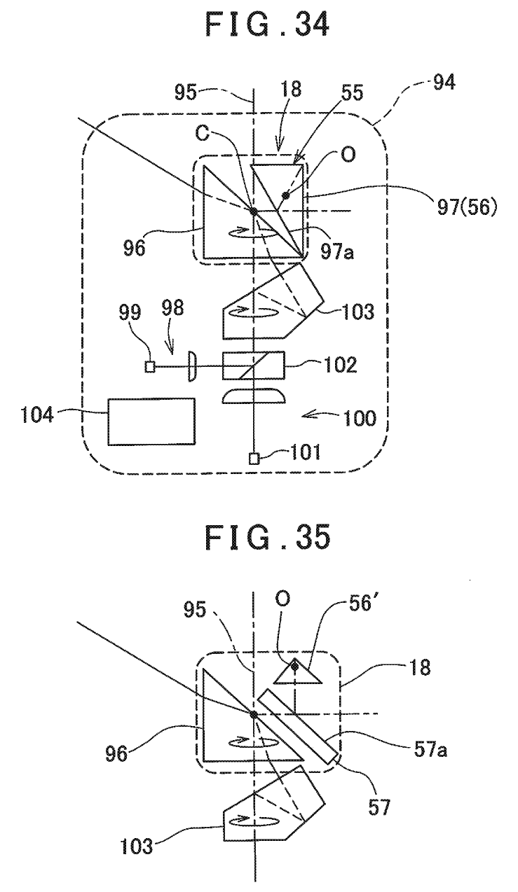

FIG. 34 shows the sixteenth embodiment. The sixteenth embodiment illustrates an application of the present disclosure to an omnidirectional LiDAR 94 with a vertical axis as the rotation axis.

The omnidirectional LiDAR 94 is briefly described as follows. In FIG. 34, reference numeral 18 denotes a vertical rotation unit that rotates horizontally about the vertical axis 95. The rotation unit 18 includes a scanning triangular prism 96 and a deflecting corner-cube prism 97 as the optical member 56.

In FIG. 34, reference numeral 98 denotes a emission optical system including a laser light source 99, reference numeral 100 denotes a receiving optical system including a light receiving element 101, and reference numeral 102 denotes a beam splitter or mirror as an optical path splitting member.

On the vertical axis 95, between the rotation unit 18 and the optical path splitting member 102, a reflection deflection prism 103 that rotates integrally with the rotation unit 18 is provided. Reference numeral 104 denotes a control unit.

Distance measurement light emitted from the laser light source 99 is reflected onto the vertical axis 95 by the optical path splitting member 102, deflected by the reflection deflection prism 103, and enters the scanning triangular prism 96, where it is reflected. By rotating the scanning triangular prism 96, the distance measurement light is horizontally scanned.

Distance measurement light reflected by the measurement target enters the scanning triangular prism 96, and is further transmitted through the reflection deflection prism 103, the optical path splitting member 102, and the receiving optical system 100 to the light receiving element 101, where it is received. Measurement is performed by the control unit 104 based on the received result.

Next, the deflecting corner-cube prism 97 is provided facing the reflective surface of the scanning triangular prism 96. When the omnidirectional LiDAR 94 is measured by another surveying device 200, the distance measurement light from the surveying device 200 enters the deflecting corner-cube prism 97, is retroreflected by the deflecting corner-cube prism 97, and the optical center O of the deflecting corner-cube prism 97 is measured.

The virtual image of the optical center O formed by the reflective surface 97a of the deflecting corner-cube prism 97 is set to coincide with the instrument center C of the omnidirectional LiDAR 94. Therefore, by measuring the optical center O, the instrument center C of the omnidirectional LiDAR 94 can be measured.

The deflecting corner-cube prism 97 includes a corner cube as the optical member 56 and the reflective surface 97a that forms the virtual image, and the deflecting corner-cube prism 97 alone functions as the target 55.

Furthermore, since the deflecting corner-cube prism 97 rotates integrally with the rotation unit 18, the position of the deflecting corner-cube prism 97 (instrument center C) can be measured from all directions.

By rotating the rotation unit 18 through a full circle, the deflecting corner-cube prism 97 functions as an omnidirectional prism. In this case, the position of the optical center O of the deflecting corner-cube prism 97 is equivalent to the position of the instrument center C in all directions, so no offset occurs between the optical center O and the instrument center C, enabling highly accurate measurement.

Moreover, the omnidirectional LiDAR 94 can also be used as a target equipped with an omnidirectional prism.

FIG. 35 shows a modification of the sixteenth embodiment.

This modification shows a case where a corner cube 56′ and a mirror 57, which are equivalent to the deflecting corner-cube prism 97, are provided as optical members. The target is constituted by the corner cube 56′ and the mirror 57.

Distance measurement light incident on the mirror 57 is deflected by the reflective surface 57a, enters the corner cube 56′, and is retroreflected by the corner cube 56′. In this modification, by providing the mirror 57, the degree of freedom in the installation position of the corner cube 56′ is increased. Furthermore, the mirror 57 and the corner cube 56′ can be miniaturized, and the rotation unit 18 can be made lighter.

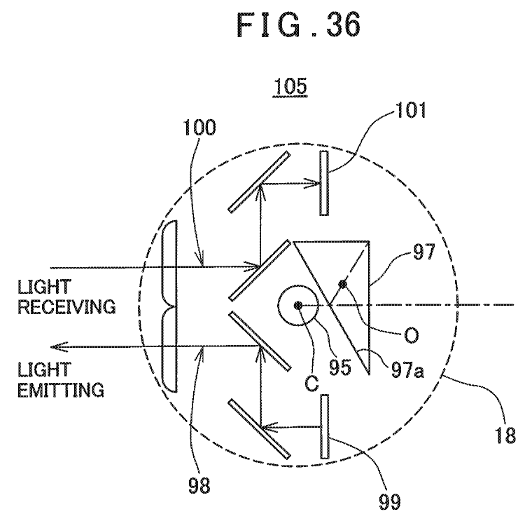

FIG. 36 shows another omnidirectional LiDAR 105 to which the present disclosure is applied, with a vertical axis as the rotation axis. In FIG. 36, components equivalent to those in FIG. 34 are denoted by the same reference numerals, and their description is omitted. In this modification, as in the sixteenth embodiment, a deflecting corner-cube prism 97 is provided as the target.

The omnidirectional LiDAR 105 has a rotation unit 18, in which the emission optical system 98 and the receiving optical system 100 are housed. The rotation unit 18 rotates horizontally about the vertical axis 95. In the omnidirectional LiDAR 105, the emission optical system 98 and the receiving optical system 100 are completely separated and arranged in a planar configuration. The virtual image of the optical center O formed by the reflective surface 97a of the deflecting corner-cube prism 97, i.e., the target center O′, is provided at the position of the instrument center C, as in the sixteenth embodiment.

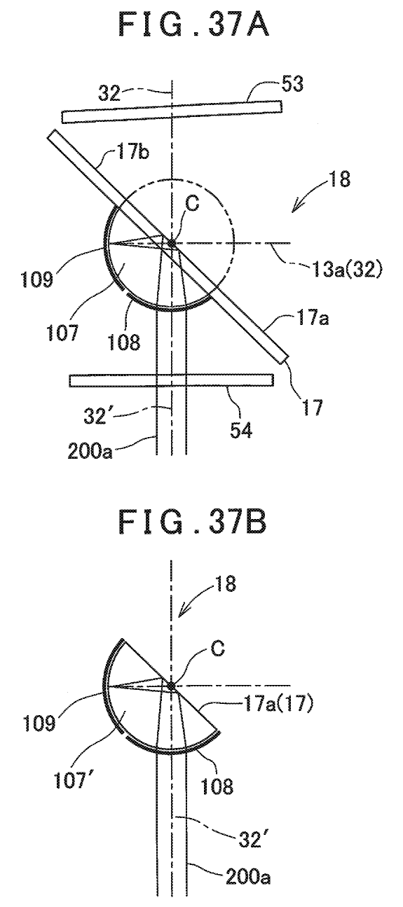

FIG. 37A explains the seventeenth embodiment.

FIG. 37A shows the rotation unit 18 of the surveying device body 4 (see FIGS. 2 and 3). The rotation unit 18 includes a scanning mirror 17, a first window 53, and a second window 54, and is configured to rotate vertically about the axis 13a.

In the figure, the axis 13a coincides with the emission optical axis 32 of the distance measurement light and tracking light emitted from the distance-measurement portion (not shown).

The first reflective surface 17a of the scanning mirror 17 is inclined at 45° with respect to the emission optical axis 32, deflects the emission optical axis 32 by 45°, and reflects incident distance measurement light vertically. The deflection point of the emission optical axis 32 on the first reflective surface 17a is the instrument center C.

On the rear surface of the scanning mirror 17, a ball lens 107 having a spherical reflective surface and retroreflective properties is provided as the optical member.

The ball lens 107 is substantially hemispherical, formed by dividing a sphere with a plane including the center of the sphere, and further retreating the dividing plane from the center of the sphere by the thickness of the scanning mirror 17. The dividing plane is optically polished.

The ball lens 107 is bonded to the rear surface of the scanning mirror 17 such that the center of the sphere coincides with the instrument center C. The refractive index of the ball lens 107 is preferably around 2.0 to improve retroreflective performance, and it is preferable that the scanning mirror 17 is made of the same material with a refractive index of around 2.0.

When the scanning mirror 17 is rotated about the axis 13a and distance measurement light is emitted from the distance measurement light emission unit, the distance measurement light is rotationally scanned about the axis 13a, and measurement is performed by receiving reflected light from the measurement target.

Next, when this measuring device is measured by another measuring device (not shown; see FIG. 4), the scanning mirror 17 is rotated such that the ball lens 107 faces the other measuring device, and the reference optical axis (emission optical axis 32′) of the ball lens 107 is directed toward the measurement target.

Distance measurement light from the other measuring device enters the ball lens 107, is reflected by the first reflective surface 17a, further reflected by the spherical surface of the ball lens 107, and again reflected by the first reflective surface 17a along the reference optical axis (emission optical axis 32′). That is, the distance measurement light from the measuring device is retroreflected by the ball lens 107.

The optical center of the ball lens 107 is its center, and since the center of the ball lens 107 coincides with the instrument center C, the measurement result obtained based on the distance measurement light retroreflected by the ball lens 107 is identical to the result of measuring the instrument center C. Therefore, in the seventeenth embodiment, the position of the surveying device can be measured accurately.

To improve the retroreflective properties of the ball lens 107, a reflective film or AR film may be formed.

In the figure, the spherical surface of the ball lens 107 is divided into two regions by a plane perpendicular to the rear surface of the scanning mirror 17 and including the instrument center C. One of the divided regions is the incident region 108, and the other is the reflective region 109. An AR film is formed on the incident region 108, and a reflective film is formed on the reflective region 109. In this embodiment, the division angles of the incident region 108 and the reflective region 109 are both 90°, but the division angles are not limited to these values; for example, the division angle of the incident region 108 may be larger than that of the reflective region 109, and other modifications are possible.

By forming an AR film on the incident region 108 and a reflective film on the reflective region 109, losses during incidence of distance measurement light into the ball lens 107 are reduced, losses during reflection in the reflective region 109 are reduced, and retroreflective properties are improved.

In the seventeenth embodiment, the target is constituted by the ball lens 107 as the optical member and the first reflective surface 17a. In this embodiment, the center of the spherical reflective surface of the ball lens 107 serves as the target center O′.

FIG. 37B shows a modification of the seventeenth embodiment. In FIG. 37B, components equivalent to those in FIG. 37A are denoted by the same reference numerals, and their description is omitted.

In this modification, a complete hemispherical mirror 107′ is formed by dividing a sphere with a plane including the center of the sphere, and the dividing plane serves as the first reflective surface 17a.

In this modification, the scanning mirror 17 can be omitted, and the rotation unit 18 can be made smaller and lighter.

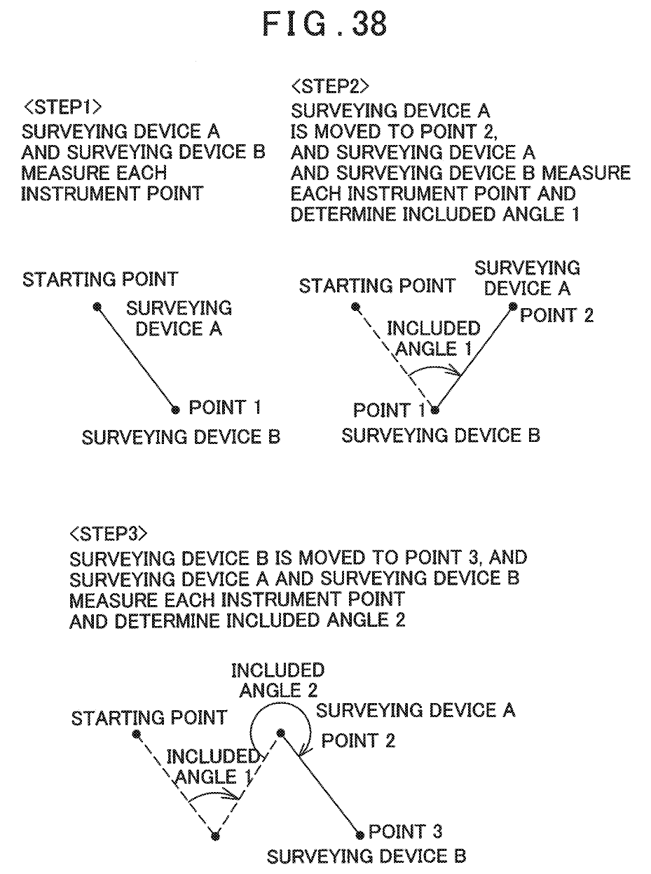

Next, FIG. 38 explains the case where traverse surveying is performed using any of the above surveying devices 1. The case of two surveying devices is described below.

STEP 1: Surveying device A is installed at the starting point (known point), and surveying device B is installed at the point to be determined (point 1). The starting point and the point to be determined are assumed to coincide with the instrument center C of each surveying device.

The instrument centers C of surveying devices A and B are measured mutually, and point 1 is made known. Surveying devices A and B then perform the required measurements.

STEP 2: Surveying device A is moved to point 2 to be determined, and surveying devices A and B mutually measure each instrument point, determine the included angle 1, and make point 2 known. Surveying devices A and B then perform the required measurements.

STEP 3: Surveying device B is moved to point 3 to be determined, and surveying devices A and B mutually measure each instrument point, determine the included angle 2, and make point 3 known. Surveying devices A and B then perform the required measurements.

STEP 4: The surveying devices are sequentially moved to the points to be determined, and the above procedure is repeated to measure the points to be determined. After moving, the required measurements are performed at each position.

In the above traverse surveying, since the target 55 has a retroreflective angle of view, measurement is performed such that the included angle and vertical angle are within the angle of view. In this case, each surveying device may have a communication function to mutually communicate whether it is within the angle of view, or the surveyor may specify the direction of the surveying device.

When searching for the position of a moved surveying device, a surveying device with a tracking function may track the moving surveying device, or in surveying using a laser scanner function, the vicinity of the point to be determined may be scanned to detect the moving surveying device.

Since the surveying device 1 described above has a target 55 with retroreflective properties, when measurements are performed with multiple surveying devices 1, one surveying device may be used as the target.

The embodiments of the present disclosure have been described above with reference to the drawings, but these are examples of the present disclosure, and various configurations other than those described above may be adopted.

Some or all of the above embodiments may be described as follows, but are not limited thereto.

### ADDITION

1. A surveying device comprising: a rotation unit that accommodates at least part of an optical system of the surveying device or the entirety thereof, the rotation unit having an instrument center of the surveying device; a target that is a second optical system having a retroreflective function and a target center, wherein the optical system of the surveying device has a collimation optical axis, and the target has a reference optical axis; wherein the target is provided with the target center coinciding or substantially coinciding with the instrument center; and wherein, upon rotation of the rotation unit, the reference optical axis of the target is configured to coincide or substantially coincide with a direction of the collimation optical axis of the optical system of the surveying device.

2. The surveying device of above-mentioned 1, where in the target comprises a reflective surface that forms a virtual image, and an optical member having a retroreflective characteristic and an optical center, the reflective surface being configured to form a virtual image of the optical center at the target center.

3. The surveying device of above-mentioned 1, wherein the target comprises a reflective surface that forms a virtual image, and an optical member having a retroreflective characteristic and an optical center, the reflective surface being configured to form a virtual image of the optical center at the instrument center.

4. The surveying device of above-mentioned 2 or 3, wherein the optical member is a corner cube.

5. The surveying device of above-mentioned 4, wherein the corner cube is a deflecting corner-cube prism having a corner-cube portion and a deflection reflective surface, and the deflection reflective surface is configured to deflect a light ray entering the deflecting corner-cube prism toward the corner-cube portion.

6. The surveying device of above-mentioned 5, wherein the deflection reflective surface functions as the reflective surface.

7. The surveying device of above-mentioned 2 or 3, wherein the optical member is composed of at least three mirrors.

8. The surveying device of above-mentioned 2 or 3, wherein the optical member is a retroreflective sheet.

9. The surveying device of above-mentioned 1, wherein the target comprises a ball lens or a hemispherical mirror having a spherical reflective surface, a center of the spherical reflective surface functioning as the target center, and the target is positioned such that the center of the spherical reflective surface coincides or substantially coincides with the instrument center of the surveying device.

10. The surveying device of c above-mentioned 2, wherein the rotation unit comprises a scanning mirror that scans distance-measurement light, and a rear surface of the scanning mirror serves as the reflective surface.

11. The surveying device of above-mentioned 2, wherein the rotation unit comprises a scanning mirror that scans distance-measurement light, and a mirror having the reflective surface is positioned on a rear surface side of the scanning mirror.

12. The surveying device of above-mentioned 11, wherein the mirror has a chevron-shaped cross section, and the reflective surface comprises two reflective faces sandwiching a ridge line, each of the reflective faces having the optical member disposed opposite thereto.

13. The surveying device of above-mentioned 11, wherein the scanning mirror has a Dach reflecting surface, and a mirror having a chevron-shaped cross section is provided for each reflective face constituting the Dach reflecting surface, each optical member being disposed opposite a respective one of two reflective faces sandwiching a ridge line of the mirror.

14. The surveying device of above-mentioned 2 or 3, wherein the rotation unit comprises the optical system of the surveying device and is configured to house the optical system therein, a reflective surface is positioned near the optical system, the optical member is disposed opposite the reflective surface, a window is formed in the rotation unit, and configured such that the optical member can be sighted through the window.

15. The surveying device of above-mentioned 2 or 3, wherein the rotation unit comprises the optical system of the surveying device, the reflective surface is disposed outside the rotation unit, and the optical member is disposed opposite the reflective surface.

16. The surveying device of above-mentioned 10 or 11, wherein the surveying device is a total station, the rotation unit is positioned at a distal end of a telescope portion of the total station, and distance-measurement light and tracking light are emitted and received through the rotation unit.

17. The surveying device of above-mentioned 16, wherein a receiving optical system housed in the telescope portion comprises an eyepiece optical system, the eyepiece optical system comprises a Porro prism, one of the prisms constituting the Porro prism is joined with a right-angle prism to form a beam splitter, an image sensor is provided to receive light split by the right-angle prism, and the surveying device is configured to process image data from the image sensor to generate an erect image.

18. The surveying device of above-mentioned 2 or 3, wherein the surveying device is a laser scanner, the rotation unit comprises a scanning mirror, a mirror having the reflective surface is positioned on an outer surface of the rotation unit, an optical member is positioned on a fixed portion facing the rotation unit, and the surveying device is configured such that, at a predetermined angle of the rotation unit, the reflective surface positions the target center at the instrument center.

19. The surveying device of above-mentioned 2 or 3, wherein a shutter is provided on an incident optical path of the optical member.

20. The surveying device of above-mentioned 2 or 3, wherein the shutter is provided on the front side of the optical member.

21. The surveying device of above-mentioned 2 or 3, wherein the shutter is provided in a window portion of the rotation unit.

22. The surveying device of above-mentioned 2 or 3, wherein the shutter is a mechanical shutter.

23. The surveying device of above-mentioned 2 or 3, wherein the shutter is a liquid crystal shutter.

24. The surveying device of above-mentioned 2 or 3, wherein the shutter is configured to perform transmission blocking by voltage control applied to an electrochromic element.

25. The surveying device of above-mentioned 2 or 3, wherein the shutter is configured to perform transmission blocking by voltage control applied to an electrowetting element.

26. The surveying device of above-mentioned 2 or 3, wherein the rotation unit rotates about a vertical axis, the rotation unit comprises a scanning mirror and the reflective surface that rotates integrally with the scanning mirror, and the optical member is disposed opposite the reflective surface.

27. The surveying device of above-mentioned 2 or 3, wherein the rotation unit rotates about a vertical axis, the rotation unit includes a emission optical system and a receiving optical system, the instrument center lies on the vertical axis, the rotation unit comprises the reflective surface and the optical member, and a virtual image of the optical center formed by the reflective surface is configured to coincide with the vertical axis.

28. A traverse surveying method employing a plurality of surveying devices according to any one of the above-mentioned 1 to 27, the method comprising:
placing surveying device A at a known starting point and surveying device B at a point to be determined (point 1), and measuring mutual targets between surveying device A and surveying device B to establish point 1 as known;
then placing surveying device A at the next point to be determined (point 2), and measuring mutual targets between surveying device A and surveying device B to establish point 2 as known;
subsequently moving surveying device B to point 2, and measuring mutual targets between surveying device A and surveying device B to establish point 3.

### DESCRIPTION OF REFERENCE CHARACTERS

1 surveying device
4 surveying-device main body
17 scanning mirror
18 rotation unit
23 distance-measurement portion
27 distance-measurement-light emission portion
28 tracking-light emission portion
29 distance-measurement-light receiving portion
30 tracking-light receiving portion
32 emission optical axis
55 target
56′ corner cube
57 mirror
59 deflecting corner-cube prism
60 deflecting corner-cube prism
61 retroreflective sheet
75 telescope portion
79 mirror
80 corner cube
81 reflective prism
82 reflective prism
87 rotation unit
88 mirror
93 shutter
94 omnidirectional LiDAR

1. A surveying device comprising:
a rotation unit that accommodates at least part of an optical system of the surveying device or the entirety thereof, the rotation unit having an instrument center of the surveying device;
a target that is a second optical system having a retroreflective function and a target center, wherein the optical system of the surveying device has a collimation optical axis, and the target has a reference optical axis;
wherein the target is provided with the target center coinciding or substantially coinciding with the instrument center; and
wherein, upon rotation of the rotation unit, the reference optical axis of the target is configured to coincide or substantially coincide with a direction of the collimation optical axis of the optical system of the surveying device.

2. The surveying device of claim 1, wherein the target comprises a reflective surface that forms a virtual image, and an optical member having a retroreflective characteristic and an optical center, the reflective surface being configured to form a virtual image of the optical center at the target center.

3. The surveying device of claim 1, wherein the target comprises a reflective surface that forms a virtual image, and an optical member having a retroreflective characteristic and an optical center, the reflective surface being configured to form a virtual image of the optical center at the instrument center.

4. The surveying device of claim 2, wherein the optical member is a corner cube.

5. The surveying device of claim 4, wherein the corner cube is a deflecting corner-cube prism having a corner-cube portion and a deflection reflective surface, and the deflection reflective surface is configured to deflect a light ray entering the deflecting corner-cube prism toward the corner-cube portion.

6. The surveying device of claim 5, wherein the deflection reflective surface functions as the reflective surface.

7. The surveying device of claim 2, wherein the optical member is composed of at least three mirrors.

8. The surveying device of claim 2, wherein the optical member is a retroreflective sheet.

9. The surveying device of claim 1, wherein the target comprises a ball lens or a hemispherical mirror having a spherical reflective surface, a center of the spherical reflective surface functioning as the target center, and the target is positioned such that the center of the spherical reflective surface coincides or substantially coincides with the instrument center of the surveying device.

10. The surveying device of claim 2, wherein the rotation unit comprises a scanning mirror that scans distance-measurement light, and a rear surface of the scanning mirror serves as the reflective surface.

11. The surveying device of claim 2, wherein the rotation unit comprises a scanning mirror that scans distance-measurement light, and a mirror having the reflective surface is positioned on a rear surface side of the scanning mirror.

12. The surveying device of claim 11, wherein the mirror has a chevron-shaped cross section, and the reflective surface comprises two reflective faces sandwiching a ridge line, each of the reflective faces having the optical member disposed opposite thereto.

13. The surveying device of claim 11, wherein the scanning mirror has a Dach reflecting surface, and a mirror having a chevron-shaped cross section is provided for each reflective face constituting the Dach reflecting surface, each optical member being disposed opposite a respective one of two reflective faces sandwiching a ridge line of the mirror.

14. The surveying device of claim 2, wherein the rotation unit comprises the optical system of the surveying device and is configured to house the optical system therein, a reflective surface is positioned near the optical system, the optical member is disposed opposite the reflective surface, a window is formed in the rotation unit, and configured such that the optical member can be sighted through the window.

15. The surveying device of claim 2, wherein the rotation unit comprises the optical system of the surveying device, the reflective surface is disposed outside the rotation unit, and the optical member is disposed opposite the reflective surface.

16. The surveying device of claim 10, wherein the surveying device is a total station, the rotation unit is positioned at a distal end of a telescope portion of the total station, and distance-measurement light and tracking light are emitted and received through the rotation unit.

17. The surveying device of claim 16, wherein a receiving optical system housed in the telescope portion comprises an eyepiece optical system,
the eyepiece optical system comprises a Porro prism,
one of the prisms constituting the Porro prism is joined with a right-angle prism to form a beam splitter,
an image sensor is provided to receive light split by the right-angle prism, and the surveying device is configured to process image data from the image sensor to generate an erect image.

18. The surveying device of claim 2, wherein the surveying device is a laser scanner,
the rotation unit comprises a scanning mirror,
a mirror having the reflective surface is positioned on an outer surface of the rotation unit,
an optical member is positioned on a fixed portion facing the rotation unit, and the surveying device is configured such that, at a predetermined angle of the rotation unit, the reflective surface positions the target center at the instrument center.

19. The surveying device of claim 2, wherein a shutter is provided on an incident optical path of the optical member.

20. The surveying device of claim 2, wherein the rotation unit rotates about a vertical axis, the rotation unit comprises a scanning mirror that scans distance- measurement light and a reflective surface that rotates integrally with the scanning mirror, and the optical member is positioned opposite the reflective surface.

21. The surveying device of claim 1, wherein the rotation unit rotates about a vertical axis, the rotation unit comprises a light-emitting optical system and a light-receiving optical system,
the instrument center is aligned with the vertical axis,
the rotation unit comprises the target, and
the target center is aligned with the vertical axis and coincides or substantially coincides with the instrument center.
